(19) United States
(12) Patent Application Publication
(10) Pub. No.: US 2010/0088716 A1
(43) Pub. Date: Apr. 8, 2010

(54) CONTENT SLOTS FOR DIGITAL MEDIA

(75) Inventors: Manohar Ellanti, Fremont, CA (US); Ram Balaraman, Palo Alto, CA (US)

Correspondence Address: KNOBBE MARTENS OLSON & BEAR LLP, 2040 MAIN STREET, FOURTEENTH FLOOR, IRVINE, CA, 92614, US

(73) Assignee: SOFTHILLS CORPORATION, Fremont, CA (US)

(21) Appl. No.: 12/244,729

(22) Filed: Oct. 2, 2008

(51) Int. Cl. H04N 7/10; H04N 7/00

(52) U.S. Cl. 725/32; 386/95; 386/E05.001

(57) ABSTRACT

A method wherein digital content, distributed on DVD (standard and High Definition variants such as Blue-Ray), CD (Computer Disk), or other digital storage media or downloaded as one or more files or streamed or broadcast is played interspersed with one or more advertising slots (also referred to in this disclosure as just-in-time content slots). Also detailed is method and steps for discovery of advertising slot information and fetching content for each slot by DVD players or end-user equipment that enable just-in-time content slots per this disclosure. Also included is method and steps for managing DVD advertising slot inventory, targeting of advertisements, building and operating advertising network including market place for buying/selling/auctioning advertising spot inventory, making available advertisements for pickup by advertising slot publishers, and tracking of advertising performance as well as tracking of advertising slot performance. Further, method and steps to enable new advertising offerings, such as variable CPM, based on the length of advertising that has been watched plus method and steps to provide auto-detection of end-of-content is detailed which can facilitate new rental/purchase business models. Included are also method and steps for integrating social networking aspects.

### BACKGROUND

1. Field

The present disclosure is related to adding one or more content slots into digital content distributed on a digital media. More particularly, the present disclosure relates to slots added to digital content that can be used to play auxiliary content, such as advertisements, trailers, enhanced/replacement content, etc. The disclosure also relates to a framework for enabling interactive digital content applications.

2. Description of the Related Art

In a typical digital video disc (DVD), various advertisements, skippable or non-skippable, can be inserted at the beginning and such content is considered auxiliary content. However, this content is static in nature in that the auxiliary content played must be pre-recorded to the DVD and cannot be changed. Conventional digital content playback does not support the concept of dynamic slots or a framework that supports dynamic auxiliary content, such as advertisements.

Dynamic auxiliary content on digital media, however, could have a large potential market. For example, according to the Digital Entertainment Group (DEG) DVD sales/rentals totaled around $23 billion in 2007 and about an estimated 90 million households have a DVD player or similar device.

Unfortunately, as noted above, this form of digital media is currently unable to provide contemporary or fresh advertisements. These numbers imply a huge viewership base that is not shown contemporary commercials, and in particular, targeted advertisements. This represents a loss of opportunity for the digital media value chain and potential customers for businesses wishing to reach out via campaigns, infomercials, advertisements, and the like.

### BRIEF DESCRIPTION OF THE DRAWINGS

The accompanying drawings, which are incorporated in and constitute a part of this specification, illustrate embodiments of the disclosure and together with the description, serve to explain the principles of the disclosure. In the figures:

FIG. 1 shows a high level framework of the entities that may be involved in slot based digital media advertising system and exemplary interactions between the entities.

FIG. 2 shows exemplary layout of auxiliary content slots on a digital medium, such as DVD.

FIG. 3 shows exemplary options for rendering auxiliary content slots included on a digital medium, such as DVD.

FIG. 4 illustrates use of auxiliary slot concept for copy protection.

FIG. 4a illustrates variation of copy protection scheme involving generation of copy protection signature from deliberately created slots/gaps

FIG. 5 shows examples of providing slot information to a media player.

FIG. 5a shows exemplary combinations between legacy DVDs, legacy DVD players, standard slot based DVDs, proprietary slot based DVDs, slot aware non-proprietary DVD players, and slot aware proprietary DVD players.

FIG. 6 shows exemplary DVD data layout schemes for embedding information of one more slots.

FIG. 7 shows an exemplary architecture of a DVD player that supports auxiliary content such as advertisements in slots on a digital content distributed on digital medium, such as DVD.

FIG. 8 shows logical components of a system that supports slot based DVD advertisements as well as components that are involved in supporting DVD applications.

FIG. 8a shows possible entities and exemplary interactions between them as part of slot based DVD advertising ecosystem.

FIG. 9 shows logical components and exemplary interactions involved in discovery of information related to one or more advertisement as well as non-advertisement slots of a digital medium, such as DVD.

FIG. 10 shows an exemplary advertisement as well as non-advertisement slot information discovery process employed by a DVD player.

FIG. 11 shows an example Blue-ray DVD original playlist for use with example modification to be shown in FIG. 12

FIG. 12 shows modified, from the original playlist shown in FIG. 11, Blue-ray DVD playlist, to include one or more advertisement as well as non-advertisement slots.

FIG. 13 shows an example of a typical Blue-ray DVD original playlist for use with example manipulation to be shown in FIG. 14.

FIG. 14 shows an exemplary method of manipulating a Blue-Ray original playlist to create new playlist that results in playback of DVD interspersed with one or more advertisement as well as non-advertisement slots.

FIG. 15 shows an exemplary process for creating advertisement as well as non-advertisement slots for a digital content distributed on digital medium, such as DVD.

FIG. 16 shows an exemplary process for the creation or updating of auxiliary content slots (for use to show auxiliary content such as advertisements) for non-theater viewing of a DVD

FIG. 17 shows an exemplary process for the creation or updating of auxiliary content slots (for use to show auxiliary content such as advertisements) for a theater showing of a DVD.

FIG. 18 shows entities and exemplary interactions that support active advertisement slots for a digital content distributed on a digital medium, such as DVD.

FIG. 19 shows an exemplary process flow for tagging advertisement slots as active following purchase/rental of a digital medium, such as DVD

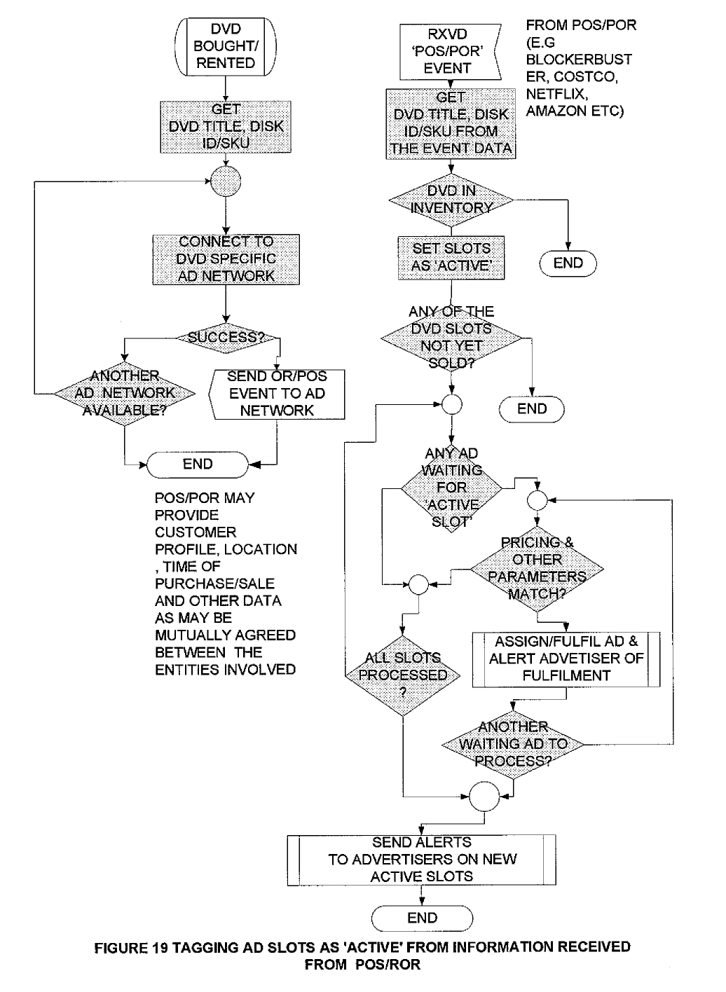

FIG. 20 illustrates exemplary entities and interactions between them in support of DVD theater enablement

FIG. 21 illustrates exemplary process flow for DVD Theater and where the process executes on a DVD Theater Application server

FIG. 22 illustrates continuation of exemplary process flow for DVD Theater and where the process executes on a DVD Theater Application server

FIG. 23 illustrates continuation of exemplary process flow for DVD Theater and where the process executes on a DVD Theater Application server

FIG. 24 illustrates an exemplary process flow for finding matching advertisement slots following a request from an advertiser for placing an in one or more advertisement slots on one or more digital media, such as DVDs

FIG. 25 illustrates an exemplary sub process flow, used by process flows shown in FIGS. 24 and 26, for matching an advertisement with an advertisement slot.

FIG. 26 illustrates an exemplary process flow for finding a matching advertisement following a request from a DVD player for advertisement for showing it in a slot during playback of digital media, such as DVD

FIG. 27 illustrates an exemplary sub process flow, employed by process in FIG. 26, for checking if parameters of a given advertisement matches with parameters of a given slot as well as budget considerations of the given advertisement.

FIG. 28 illustrates an exemplary process flow for updating advertisement statistics maintained at one or more tracking services associated with the advertisement.

FIG. 29 illustrates exemplary process flow involved in DVD Trailer enablement and where the process executes on a DVD Trailer application server.

FIG. 30 illustrates exemplary display options for use by DVD Interactive applications enabled by this framework.

FIG. 31 shows exemplary presentation organization/layout of DVD information to enable interactivity and to show archived interactive inputs (such as comments etc) along side DVD theater schedule.

### DETAILED DESCRIPTION

The present disclosure describes embodiments of a system and method for creation and use of dynamic auxiliary content slots for showing auxiliary content. For example, this auxiliary content may be advertisement content that is played during playback of digital content distributed on a DVD or other form of digital medium. Auxiliary content for each slot can be obtained from the same source (DVD, file server, streaming channel, etc) as the digital content (or main content) or from other sources, such as online sources, or websites. Auxiliary content shown in these slots may be targeted based on a variety of factors. For example, advertisements may be targeted based on characteristics of the renter/buyer/viewer of the digital content as well as based on the rating of the digital content.

As noted, embodiments of the present disclosure provide a method of playing digital content interspersed with one or more dynamic auxiliary content slots. Attributes of a slot can designate the type of information included in the slot, such as advertising slot, trailer slot, replacement/enhanced content slot and so on. If a slot is designated as an advertisement slot then the slot can be used to show advertisements. These advertisements may be from a DVD ad network or other source.

If a slot is designated as trailer, then content in the slot can be treated as a trailer and a viewer may be allowed to share that trailer with friends or others. The trailer content may be fetched from the same source as the main content or from an online source. Trailers may also contain enhancements that are supported via online sources. If the slot attributes indicates the slot is an enhanced/replacement content slot, then the player may fetch enhanced/replacement content from the same source as the main content or from another online source. Many variations are possible with embodiments of the present disclosure.

In this disclosure, the term ‘advertisement slot’, ‘advertising slot’, ‘auxiliary content slot’ or ‘trailer slot’, ‘replacement slot’, ‘enhanced content slot’ and simply ‘slot’ may all refer to slots utilized by embodiments of the present disclosure. In this disclosure, the terms ‘ad slot’, ‘advertisement slot’, ‘advertising slot’, ‘ad spot’ are intended to refer slots that are designated to carry advertisements. Similarly terms ‘digital content’, ‘main content’, ‘DVD’, ‘content/DVD’, are used in this disclosure interchangeably to refer to digital content for which one or more auxiliary content slots are associated. The term ‘player’, ‘DVD player’, ‘content player’, ‘stream player’, ‘file download player’ are used in this disclosure interchangeably to refer to any device or software that performs playback of digital content.

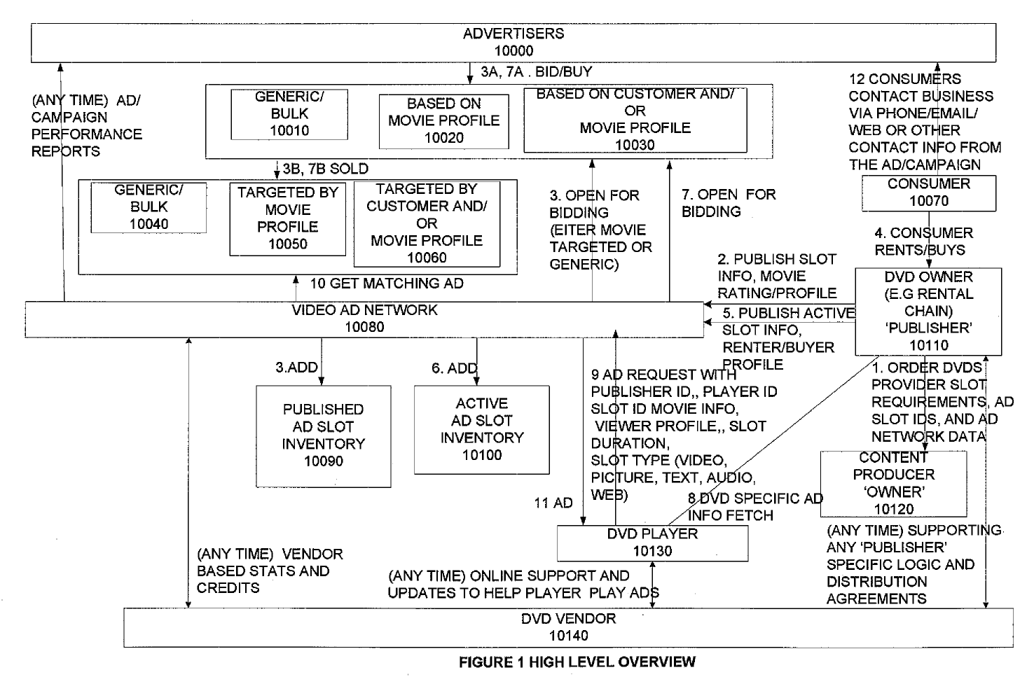

Each slot can be played at an intended relative time during the playback of the main content. As illustrated in FIG. 1, one or more slots can be created per DVD at various times in the digital content (e.g., a movie). At the designated time of a slot, the player will play auxiliary content associated with the slot. Auxiliary content to be shown in the slot can be obtained from the same source as the main content or from a separate source. When content for a slot is on a DVD, slot information can include location information of auxiliary content on the DVD. When content for a slot is sourced from a file download (which may comprise one or more files), the slot information may include location of the auxiliary content in the file download (such as, filename and offset). When content for a slot is sourced from a streaming channel, such as Video-On-Demand (VOD), and a slot for that content indicates that auxiliary content for that slot also comes from the streaming channel then slot information can include additional information (such as, an MPEG stream ID) to help the player get auxiliary content. In case of TV broadcast channel, if the slot information indicates that the auxiliary content comes from the TV broadcast itself then it can include channel ID to help player get the auxiliary content. The player might switch tuner to the specified channel at the onset of the slot and switch back to regular channel at the end of the slot.

The location of the slot may be specified in time and, in one embodiment, is specified relative to the movie run time. For example, this feature may be useful to account for interruptions or changes in the playback of the digital content, such as, when the viewer pauses play while watching a segment which will make view time of that segment as well as that of the movie longer than its run time. It is also possible for a player to freeze playback while fetching DVD movie data from storage or network. In general, since the run time can be different from actual view time, some embodiments may thus employ relative time.

The slot structure can be designed in different ways to optimize sponsorship opportunity. For example, a repetitive slot may be shown periodically or at random intervals throughout the DVD playback. Such a slot may be used for advertisements associated with branding or for other messaging needs of advertisers. Slots layout can also be decided at the time of DVD authoring or at the time DVD is added to the ad ecosystem or at the time request is received for slot information for a given content/DVD from player. Request from a DVD player to get slot information may include viewer profile which can be an additional input into slot layout decision. Where a player is not able to provide viewer profile, a slot information server (also called ‘ad slot info server’ or ‘ad info server’ or simply ‘slot info server’) can, based on disk SKU or other such information on the disk, find viewer profile through backend integrations with one or more known entities of content/DVD ecosystem. Rules can be setup on an advertising information server which serves a slot table to the player on request. Given this, for the same DVD title viewed at two different times or by two different viewers, a slot table served can different. Accordingly, this disclosure supports customization of slot layout per DVD, per viewing and supports both static and dynamic ways for creation of slots.

Currently, there are advertisements over Web and on TV and associated pricing models. For example, Web advertising uses models such as cost per thousand impressions (CPM), cost-per-click/price-per-click (CPC/PPC), and click-to-call/price-to-action (CTC/PAC) and others. Similarly, TV uses advertising duration, prime-time and other time/event/show sensitive pricing models.

However, TV advertisements are priced based on projected/expected viewership of a show as well as audience profile. Projections and audience profile may be based on ratings, such as available from Nielsen™ or others, and based on other considerations. In general, TV advertising charging can be considered as ‘before-the-fact’. On the other hand, Web advertising charging is ‘after-the-fact’ since it is based on how many impressions have actually been served or clicked or resulted in action.

A slot-based advertising framework proposed in this disclosure brings ‘after-the-fact’ Web advertising models as well as the appeal of TV style advertisement opportunities to digital content distributed on DVD or otherwise. This will help DVD advertisers pay, based on actual number of views or clicks or actions. Besides, bringing TV and Web advertising models, style and appeal to DVD, this disclosure solves a common issue with both TV and Web advertising—both lack feedback/confirmation after user has seen an advertisement. For instance, a Web page containing advertisement outside visible area can be counted in Web CPM models. Even if an advertisement is in the visible area of a Web page it can still be effectively invisible if a user didn't look at the advertisement (‘ignore’ phenomenon). While TV ads are always in the visible area and hence don't have the visibility issue they do have an ‘ignore’ issue, if a viewer skips them using a digital video recorder (DVR) or such solutions provided by TiVo™ and others. Advertisements that were not visible or ignored/skipped should not be counted into CPM.

In contrast, this disclosure will enable advertisements that were ignored/skipped to be tracked and not counted for purposes of reimbursement. In general, feedback/confirmation mechanisms enabled by embodiments of this disclosure can make video advertising models more effective and help advertisers pay by number of showings/viewings (i.e. impressions) and in case of video advertisements by length of the advertisement that has been actually watched. Such viewed-length based analytics can help video advertising viewership/audience to be broken into groups. Such breakdown allows discounts to advertisements that have been skipped either from their start or from somewhere in the advertisement to the end. This can be very useful for advertisers to consider into their campaign budget and campaign design itself.

For example, they can break the advertisement dollars allocation into 100% viewed, 50% viewed, 10% viewed, skipped-after-start, skipped-end, completely-skipped and other variations. Campaign, commercial, or advertisement embodiments may be structured or designed to have a prologue containing a summary message, brand name, etc. followed by a body and an epilogue. The epilogue may be either a repeat/variation of the prologue or a new segment that contains information to help a viewer interested in products/services in the commercial to contact the business.

As mentioned earlier, conventional TV has its own unique advertising offerings that are based on such factors as prime-time, and popularity of the show/event. TV advertisements rates are based on these and other factors and available inventory is sold or auctioned off ahead of time. In the present disclosure, the advertising slot framework allows for realizing a similar, but unique advertising models for DVD as well.

For example, in some embodiments, DVD viewing times may be analyzed to find a pattern and, based on that pattern, determine DVD prime-times. For example, evenings on Friday/Saturday/Sunday may be the most common time that a DVD is viewed. Advertising slots that will be played on Friday and weekends may be declared as ‘prime-time’ and priced higher. Similarly, if a movie was a blockbuster at theaters, it is very likely the DVD will also have a sizeable viewership in the first few days and weeks. This can be taken advantage of by auctioning the advertising slots related to a new DVD at a higher price.

Reference will now be made to the figures to discuss embodiments of the present disclosure. FIG. 1 shows a high level framework of the entities that may be involved in slot-based digital content advertising system and exemplary interactions. As shown, the system may comprise one or more advertisers 10000, one or more consumers 10070, a video advertising network 10080, a slot publisher 10110, a content producer 10120, a player 10130, and a DVD player vendor 10140. These entities and various interactions between them will now be further described.

Advertisers 10000 represent entities that provide advertising content for advertisement slots of a digital content distributed on media, such as a DVD, downloaded files, or streaming channels. Of course, other types of entities may provide content for slots used in embodiments of the present disclosure.

Consumers 10070 represent persons that may purchase or rent or view the digital medium. For example, consumers 10070 may purchase DVDs at stores like, Costco™, Amazon™ or other places. Such sales places are called Point-of-Sales (POS). Consumers may also rent from rental places like Blockbuster™, NetFlix™. Such rental places are called Point-of-Rental (POR).

Video advertising network 10080 may be any system that maintains an inventory of advertising slots and commercials. Advertising slot inventory may be grouped for helping with sales and organization. For example, as shown in FIG. 1, 10010 represents a group of generic/bulk advertisement slots that may be used to show advertisements that don't have requirements as to the digital content in which they can be shown or the viewers to whom they can be shown. Block 10020 represents advertisement slots grouped by profile of digital content in which the slots are placed; 10030 represents slots grouped by the profile of the digital content in which they are placed and of the viewers. Viewer profile may be determined from POS or POR. The slot inventory, managed by advertising network 10080, of available advertisement slots may be organized and updated when a particular DVD becomes live subsequent to purchase or rental.

It is also possible to sell/auction off all DVD advertisements as a package deal prior to the release of a DVD. For example, advertising slots for a DVD may be sold/auctioned some time in the course of movie (the content) production and prior to theater release of that movie in anticipation of the subsequent DVD release.

Using information from an advertising request, advertising network 10080 finds matching commercial and serves it to the requesting player. In that process it may make requests to advertising broker/advertising agency, if needed, including redirecting the request to another advertising network or advertising agency/broker. Advertising network receives payment from advertising sponsor or agency/broker that bought an ad slot in which an advertisement belonging to the sponsor or agency/broker is shown. It may in turn pay advertising publisher—one who owns the slot on digital content distributed on digital media such as DVD, file download, VOD or streaming.

Advertising network 10080 may utilize an advertising broker/advertising agency. An advertising agency may be any entity that auctions or buys advertising slot inventory and sells this inventory to campaign sponsors, such as advertisers 10000. These entities are typically marketing/sales organizations that work with businesses wishing to run campaigns. In some case they may work with ad slot publishers 10110 as well.

Advertising network 10080 may be managed or operated by an advertising network operator. An advertising network operator may be any entity that operates an advertising network like network 10080 that serves advertisements based on variables explicit or implicit in the advertising request from a DVD player.

Advertising networks may need to have large advertisement slot inventory, have many advertisers, and scale to be effective operationally and economically. Plus building and operating Video advertising network may not be a core function of some of the entities involved in DVD value chain. Therefore it is possible that content publishers/producers or content/DVD wholesale buyers/retailers, such as Costco™, Amazon™, etc., or content/DVD rental chains, such as Blockbuster™, NetFlix™ etc., that function in the role of ‘Advertisement Slot Publisher’ or simply ‘ad publisher’ use an advertising network operated by someone else.

In order to help advertising network operator to credit parties involved in the value chain, each DVD advertising request can contain ‘ad slot publisher’ information that is used by the advertising network operator to pay the publisher. To allow for flexible business arrangements between value chain entities ad request from player may contain multiple variables that are used by advertising network operator to pay those involved per prior agreements. For example, if B buys DVD distribution rights from content producer A, and in turn distributes/sells in bulk to C (on request/order from C) and finally C retails or rents the DVD, then for a DVD sold/rented the advertisement value chain involved might comprise of A, B, and C. In general, information related to producer, distributor, sales/rental channel can be embedded in the DVD or kept online based on serial number or bar code/SKU or disk identifier or some other information on disk. For example, if the content producer is authoring DVD for Blockbuster™ rental channel then, based on information received from Blockbuster™ at the time of DVD order, producer can embed sales/rental channel information. Depending on business arrangements, sales/rental channel entity (such as Amazon™, CostCo™, Blockbuster™) or content producer could be the ‘ad publisher’. Per wishes of ‘ad publisher’, Internet address of advertising networks to use for fetching advertisements for one or more advertisement slots associated with the DVD and other information as may be desired by business arrangements between entities involved in DVD advertisement value chain can be embedded on the DVD or kept online for that DVD.

If it is embedded in the DVD, then the DVD player can send this information to the DVD video advertising network, when it makes a request to fetch matching advertisement for a slot. If the information is not embedded in the DVD, then advertising network may use backend integrations with A, B or C (or all of them) to discover such information. For example, based on title and/or other information, such as SKU, advertising network can consult known content publishers, known distributors, known retailers, known renters, using its backend integrations, to see who is involved in the advertisement value chain of a particular DVD and based on such discovered information pay credit to those involved.

In general, slot based DVD video advertising revenue sharing can support multiple models given the availability of multiple variables in the DVD advertising request from player.

In embodiments of the disclosure, the advertisements shown in various advertisement slots may be targeted based on factors, such as, the time of view. For example, if a movie is being watched in the evening, then restaurant/food related commercials can be played. As another example, if the movie is watched after dinner, then advertising for other types of entertainment may be shown. Furthermore, if a movie is being watched around a particular time of year, such as the April 15th tax deadline, then commercials by businesses involved in tax preparation might be helpful. Likewise, if a move is being played around a particular holiday, such as New Years, July 4^{th}, etc., then relevant advertisements for those holidays may be provided. One skilled in the art will recognize that targeted advertising can be performed in wide variety of ways within the spirit of the present disclosure. For example, targeted advertising can be achieved based on one or more variables received in the DVD ad request as well as additional information derived by advertisement network contacted by the player. Targeted DVD advertising therefore may be realized using this disclosure and used to help enhance DVD advertising value proposition and thereby derive even higher advertisement value than other forms of advertisements.

Embodiments of the present disclosure may employ either skippable or non-skippable DVD advertisements. Currently, to realize non-skippable content segments, players set a flag (usually meant to be used to allow FCC copy protection warning to be played without skip). Once flag is set player ignores user's fast forward control until the segment with the flag plays out. Advertisements are placed on DVDs that use this flag for content other than FCC copy protection warning. This disclosure, in contrast to prior art, allows skippable advertisement to be realized, for example, by using ‘watched length’ feedback associated with each advertisement slot. In general ‘watched length’ feedback provides for fine grain tracking per advertisement. If for a given slot, watched length=0% then it can be inferred that advertisement shown in that slot has been skipped by user. If watched length=100% then it can be inferred that advertisement shown in that slot has been watched without skipping. Such network side software based approach allows ‘ad publishers’ to offer skippable and non-skippable advertisement slots without using complex hardware or software on player and more importantly without hijacking a mechanism that is meant for FCC copy protection warning. Non-Skippable advertisements, as enabled by this disclosure, will be less intrusive and help advertisements appear to viewers as more friendly than those that are realized using hardware or software based approaches on player that prevent user from skipping advertisement, essentially leaving no choice to the viewer.

Slots can also be used for purposes other than advertising. For example, a slot may be used to represent replacement content (to replace original content in the DVD). When player encounters replacement slot it will try to get content for the slot (just like the way it will try to get content for an advertising slot) failing which it will play the default content for that slot. The replacement slots can be used by content publishers to suit their marketing needs. For example, a replacement slot may used to show content that is specially meant for DVD viewing, including commentary etc. Also content publishers can let users share content shown in a slot with their friends that may lead them to purchase/rent that DVD. Thus, by allowing the ability to share link to a portion of the DVD or allow online discussion around portions of the DVD, the content publisher may be able to obtain a viral effect to increase viewership of that DVD.

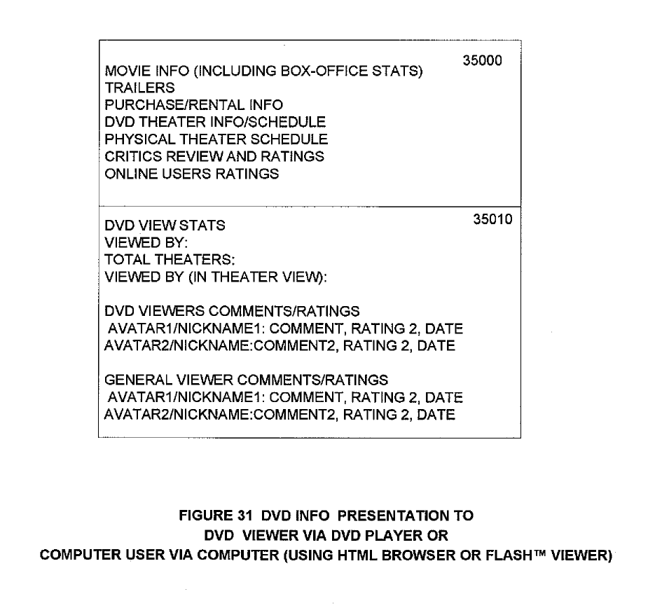

In another example, each slot could be a trailer. This enables multiple trailers. Users can be allowed to share a slot, designated as trailer, with their friends. Such sharing can lead them to purchase/rent that DVD. Content producer or publisher can design one or more trailer slots and let viewers share what they like with their friends. Essentially, each trailer brings its own popularity and interactivity to the table increasing the potential sales for the DVD. Trailer slot application will be further described later as part of FIG. 31 description.

Advertisement slot Publisher (referred to briefly as ‘ad slot publisher’ or simply ‘ad publisher’) 10110 may be any entity that owns advertising slots on one or more digital media assets, such as a DVD, etc. Depending on business arrangement, publisher 10110 can be a content producer or buyer of the content. A given business entity may play one or more of these roles. For example, a content producer (e.g. a Studio) may choose to be an Advertising publisher. Similarly, an Advertising Network operator may perform an Advertising Agency role in addition to being an advertising network operator. The following paragraphs provide brief description of each entity.

Content producer 10120 may be any entity that creates content. Such entities are well known to those skilled in the art.

Player 10130 represents any device that is capable of playing the content on a digital medium, such as a DVD or CD. For example, for purposes of illustration, the present disclosure often refers to use of a DVD player as player 10130. However, one skilled in the art will recognize that other types of devices, such as laptop computers, personal computers, game consoles, mobile phones, etc., can also be configured or adapted to play content on a digital medium, such as DVD, or delivered as one or more file downloads, or deliver over streaming channel.

Those skilled in the art will recognize that embodiments of the present disclosure may be implemented on game consoles, such as Wii™, PlayStation™, Xbox™, etc. When a DVD is played by these consoles, advertising slots of the present disclosure may provide advertisements that add interactive capabilities during or at the end of the advertising. For example, an advertisement by automobile company can be enabled for clicking during the advertising play. Advertising content sent to the player on request can be executable in addition to playback content. The executable can be in charge of the advertising presentation and interact with the user during the advertising. The advertising server may send different executables based on the requesting player profile or the profile of the console.

One skilled in the art will recognize that there are several ways to create DVD advertising as well as non-advertising slots, which may then be played by player 10130. In a first method, advertising slots are embedded at the time of DVD authoring. In a second method, advertising information is not embedded onto the DVD. Instead, the player implements advertising enablement, for example, by downloading the advertising slot information (called virtual slots) from online sources acting in the role of ‘advertisement slot info server’ (or referred briefly as ‘slot info server’) as will be explained later in this disclosure.

DVD player vendor 10140 represents any entity that provides or manufactures player 10130. Such entities are well known to those skilled in the art.

In some embodiments, methods may provide incentives to DVD player vendors 10140 (hardware or software based player vendors) to build players that play digital media advertisements as per this disclosure. For example, DVD advertising slot publishers (who own the slots) may pay DVD player vendors per each advertisement played using mutually agreed arrangements. A vendor can register with various DVD advertising publishers, or alternatively, advertising publishers may enlist several DVD vendors prior to release of new DVD title to maximize the chances of success of the DVD advertisements. Sales/rentals channels, such as Costco™, BlockBuster™, Amazon™, Wal-Mart™, NetFlix™ etc., if acting in the role of ‘ad publisher’ or otherwise, may also partner with hardware and software vendors to distribute to their customers branded or non-branded new DVD players that support the ability to insert advertisements per this disclosure. They may distribute new players, subsidized or free of cost, to their customers given the opportunity to recoup from advertisement revenue. Where sales/rental channels distribute, subsidized or free of cost, players, branded or non-branded, with the intention of recouping cost from advertising revenue will be considered as player vendor in the ensuing discussion.

In general, a process where player vendors 10140 get credit for supporting advertising slots per this disclosure may be used to subsidize the cost involved in development, manufacture and distribution of new players. For example, advertising publishers can distribute new players to their customers either for free or at subsidized cost. This approach may have several benefits. First, users may be more willing to obtain a new DVD player particularly if the player provides new capabilities (such as Internet capabilities) and other applications. Second, advertising publishers may work with partner vendors to embed advertising logic suitable to their needs into the players.

It is also possible for DVR vendors to add DVD playback capabilities to DVR devices and take advantage of the DVD advertising slots described herein to derive additional revenue. DVRs can also integrate Video-on-demand (VoD) and online movie rental downloads. Once content is on a DVR, it can be viewed in a way that is similar to inserting a physical DVD and playing it. Whether the DVR gets content from DVD disk, over a VoD stream or via file download channel, it can play that content interspersed with advertisements in accordance with the advertising slots described herein.

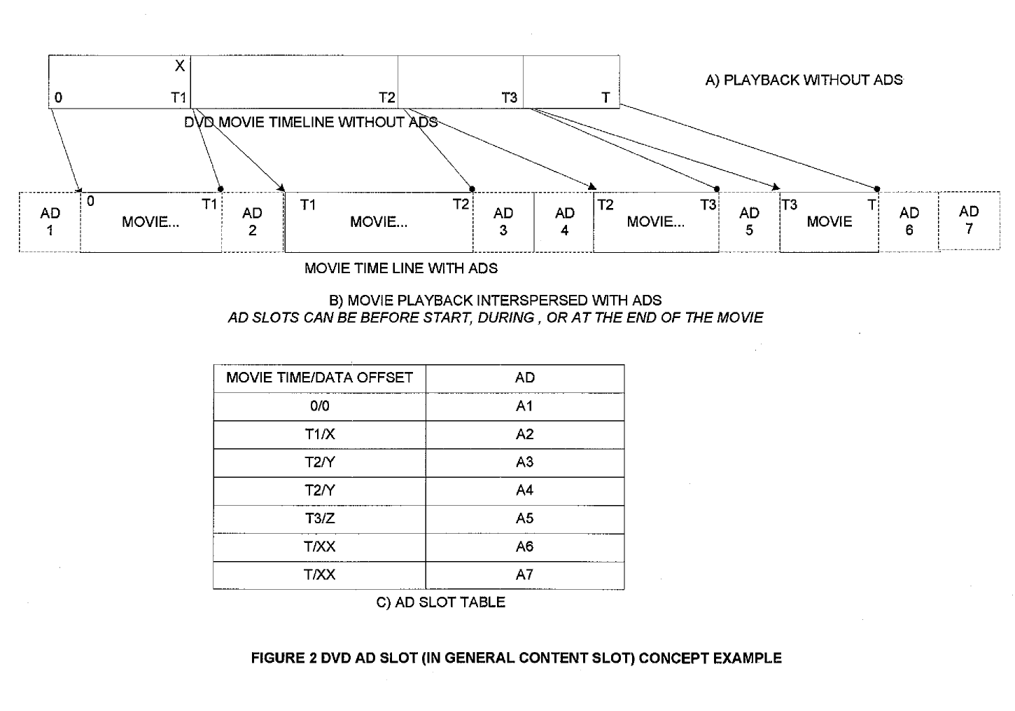

FIG. 2 shows a DVD with slots that may be used for advertising on a DVD. FIG. 2 at part (a) shows playback without advertisements of a DVD containing four slots starting at 0, t1, t2, and t3 respectively. As shown, there are two advertisements, a3 and a4 at t2, and a6 and a7 at t. When there are multiple advertisements at the same time, they may be played in the order of appearance in the advertising slot table.

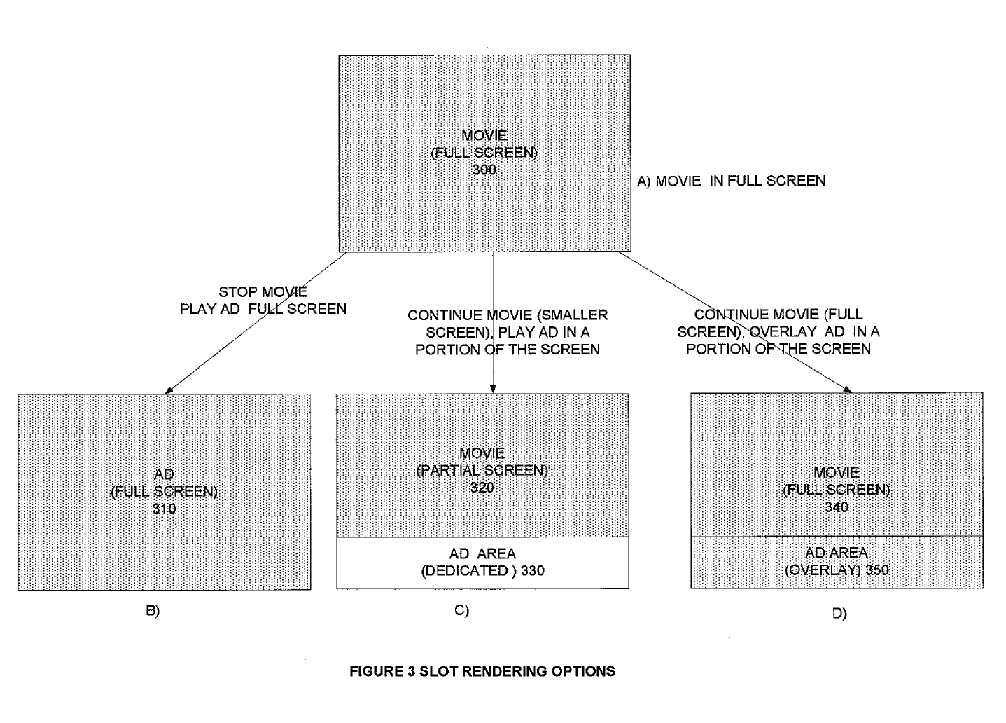

Each advertising sot can be rendered in multiple ways. For example, one option would be to stop the DVD playback, render advertising and then resume DVD playback. Another alternative comprises showing the advertising in a dedicated portion of the screen while the DVD is shown in the rest of the screen (i.e., a Picture-In-Picture or framing scheme). Yet another alternative would be to show the movie in full screen and overlay the advertising in a portion of the screen. FIG. 3 shows some examples of ways in which an advertising slot can be rendered.

FIG. 3 shows examples of how slots can be rendered. For example, during normal playback of the content, block 300 shows a full screen rendering of the content. When it's time to play an advertising slot, based on parameters associated with the advertising slot, it can be rendered using full screen (310), split-screen (320 and 330) or overlay (340 and 350).

Ad slot publisher can decide how to render slot (and thereby the advertisement or other content played for that slot) on a per slot basis or on a per DVD title basis. Alternatively, a rendering decision may be left to the player/end-user equipment. In general, rendering can be decided at the time of slot creation or at the time of playback of DVD based on various criteria, such as business or layout considerations. For example, if sub-titles are enabled and are displayed at the bottom of the screen, then rendering using example as shown in FIG. 3, block 350 may be not acceptable. In such case, the advertising may instead be overlaid either on sides of the screen or on the top portion. This framework supports the flexibility needed for multiple ways of rendering.

Also, the rendering options may affect advertising selection and pricing. For example, certain layouts may be more suitable for text based advertisements while other layouts may be preferred for video advertisements. Various rendering options may be employed to improve the likelihood of an advertising being seen by users without resorting to skipping as might happen if the advertising were shown in full screen mode.

Besides using them for showing advertisements, another use of slots in the digital media is content/copy protection. By suitably placing slots throughout a DVD, one can leave content gaps that will result in sub-par viewing experience if the DVD is viewed without filling the gaps. One can still copy such DVD, but the viewing quality of the DVD may be intentionally degraded. The DVD's intended quality may thus be repaired by fetching missing content to replace these content gaps. Intentionally removed content from one or more slots can be kept online or otherwise. Such content may be optionally encrypted and which can be decrypted after providing credentials to validate legitimate buyer/renter of the DVD. The decryption may be performed online or by player.

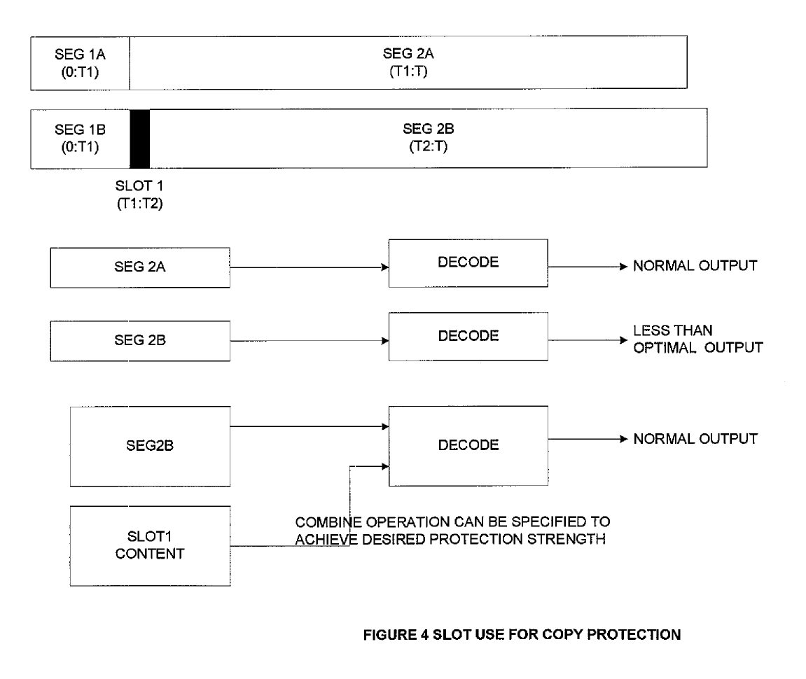

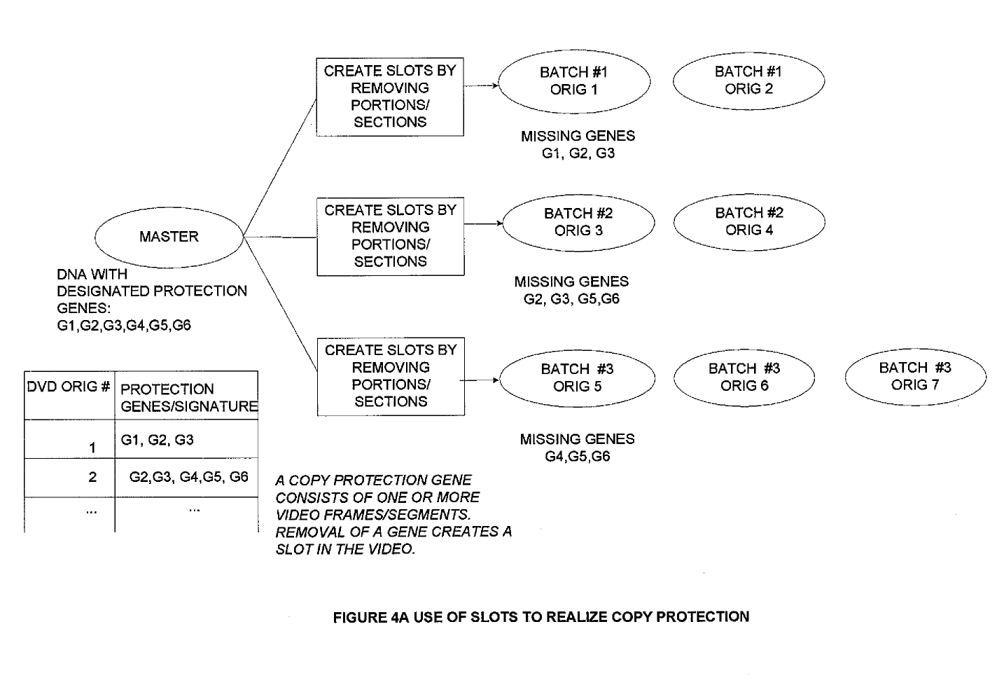

Copy protection slots can be thought of as being similar to replacement slots except that varying level of sophistication can be employed with respect to use of the content fetched (on disk or from online) for a slot designated as being for copy protection. For example, one technique is to remove a small segment and create a slot in its place. The removed segment is hosted online. When the DVD is played, content for the slot is fetched and played. Immediately after the slot, the DVD playback continues, and thus, can give the impressions that everything is coming from the main DVD source. FIG. 4 illustrates use of slot concept for copy protection as explained above. It shows original DVD with two segments (1a and 2a). Segment 1a runs from time 0 to t1 and segment 2a runs from t1 to t. Now, a copy protected DVD is created from the original by copying segment 1a as is and called segment 1b. Next, after removing portion from t1 to t2 from segment 2a a new segment, 2b, is created and copied onto the coy protected DVD. When the above copy protected DVD is played by a regular DVD player it will result in viewing experience that is less than normal because of missing content in slot 1. On the other hand, if the same DVD is played by a player that understands slot framework and can fetch the missing content (after validation of request as coming from legitimate owner) then viewing experience is the desired one.

Another technique involves removal of a segment (consisting of one or more frames) in a way that decoding of the segment that follows the removed segment requires a decoding result from the removed segment. In other words, slot content must be fed into the decoding of content that follows the slot to preserve original user experience (the one that would be obtained if the gap was not created). This is illustrated in FIG. 4 where Segment 2b and slot 1 content are fed to decoder which produces the normal output.

In general, deliberately removed content gaps, in whatever way such removed content is later combined with the rest of the DVD to get expected output, can be considered as analogous to missing genes of a DNA. A given DVD with copy protected content gaps can be considered to have a DNA and the eliminated portions/sections can be considered as missing part of that DNA. As with DNA—every human DNA is unique and therefore the missing genes fit into the DNA of one and only one DVD copy (copy created from master). So even if some one gets the missing portions/sections they can't be used with any DVD copy other than the intended one.

For example, assume that x originals of a DVD title were sold and that one of the DVDs is used to make duplicate copies. When a copied DVD is played back, it will result in player making request to get slot information and content for each slot. At this time slot info server can detect that there are requests from different users to get missing content for the same DVD copy (as indicated by the missing content DNA signature). This probably means duplicate copies of one particular DVD are in circulation.

In response, the DVD that has been copied may be rescinded. This provides for much easier approach to copy protection and enforcement compared to complicated encryptions and other means used in current standards. Another variation of the above DNA based copy protection technique involves removal of one or segments to create multiple masters. Each master can be thus be assigned a copy protection D NA signature comprising of missing content and where the signature is unique. Such signature thus created will be similar to gene based DNA signature used to identify descendants uniquely. FIG. 4a illustrates this use of slot concept to create copy-protected DVDs. For each DVD title (the master), after removing one or more segments multiple original copies are created. The protection signature of each original copy is the set of missing segments.

In general, there may be other variations that take advantage of encoding/decoding technology combined with slot concept to achieve effective copy protection and all such variations should be viewed as being within the spirit of this disclosure.

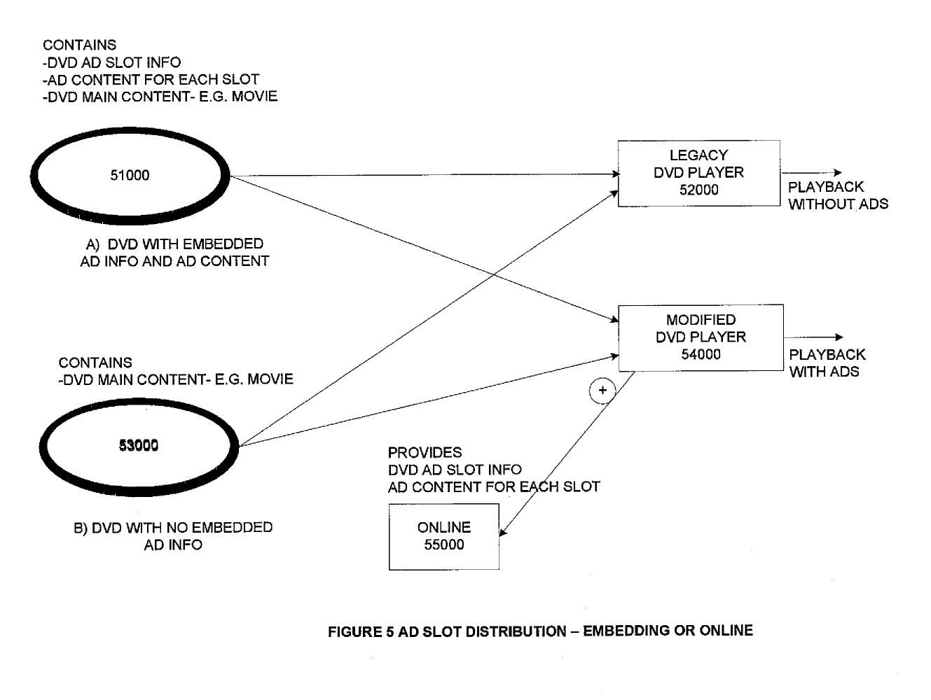

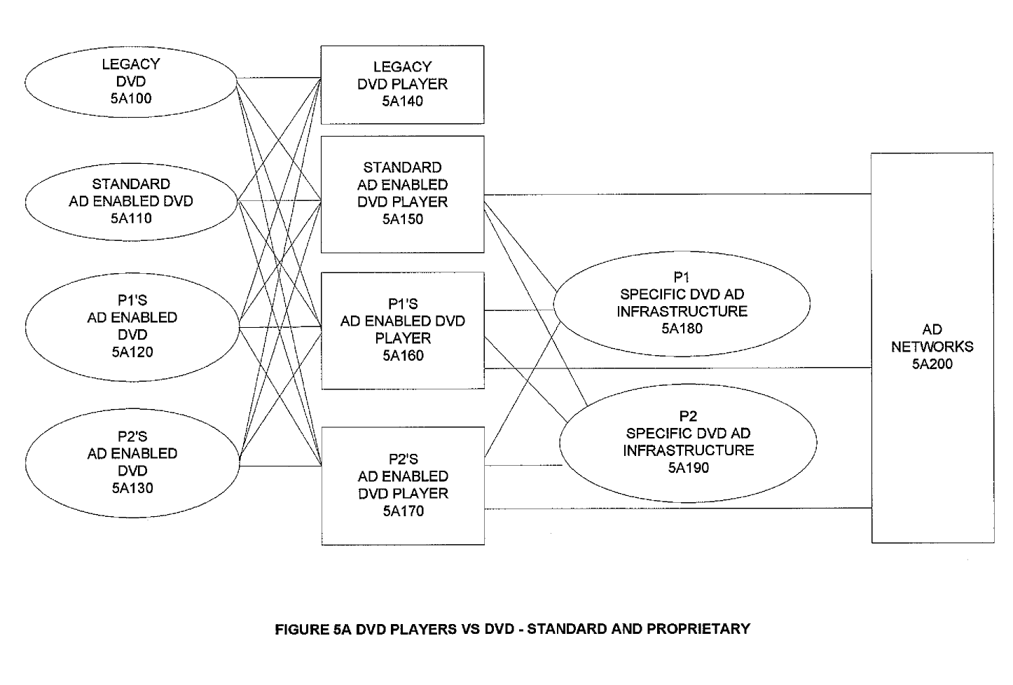

FIG. 5 shows example for embedding advertising slot information. In particular, FIG. 5 at part (a) shows an example where the DVD (61000) contains advertising slot information as well as default advertising content for one or more slots. When such DVD is played by a legacy DVD player (52000), e.g., one that doesn't support advertising enablement, it results in playback without advertisements. However, when played using a DVD player (54000) that supports advertising slot information, the DVD along with any overriding advertising slot information may be fetched online (55000) and the player playback the content interspersed with advertisements.

In FIG. 5 at part (a), a DVD is authored such that it contains main content (e.g. movie) as well as advertising slot information. Movie data, slot table, auxiliary content (such as advertisements) for showing in one or more slots, DVD playback sequence may be stored on the DVD such that legacy DVD player plays back the DVD as if slot related information is not there. Thus, the embedded slot information and auxiliary content does not effect the operation of legacy players. But, when the same DVD is played by a DVD player capable of understanding the slots, the result is a playback interspersed with slots containing auxiliary content such as advertisements.

In FIG. 5 at part (b), the DVD contains no slot information. When such DVD is played by legacy player, it results in playback without slots. When the same DVD is played by a capable DVD player, the result is playback interspersed with slots with each slot showing auxiliary content (such as advertisements) as per information stored with the slot. FIG. 5 at part (b) shows an example where the DVD (53000) does not contain slot information. When such DVD is played by a legacy DVD player (52000), it results in playback without slots. However, when played using a capable DVD player (64000), one that implements this disclosure, it results in the player fetching slot information from online (55000) and a playback interspersed with slots with each slot showing auxiliary content (such as advertisement).

FIG. 5a shows combinations possible between legacy DVDs, legacy DVD players, standard slot enabled DVDs, proprietary slot enabled DVDs, and proprietary slot enabled DVD players. For example, block 100 represents a DVD with no embedded slot information. Block 110 may represent a DVD that is slot enabled and has standard slot information (either embedded or online) suitable for playing by any player that enables auxiliary content (such as advertisements) in slots.

Block 120 may represent a DVD that is slot enabled, but has proprietary slot information (embedded or available online) suitable for playing by publisher P1's own proprietary player that enables advertisements in slots.

Block 130 may represent a DVD that is slot enabled, but has proprietary slot information (embedded or available online) suitable for playing by publisher P2's own proprietary player that enables auxiliary content (such as advertisements) in slots.

Block 140 may represent a legacy DVD player that does not enable slot and does not understand embedded slot information if any on the DVD. Its output is thus playback without advertisements.

Block 150 may represent a standard slot enabled DVD player that enables slots and understands slot information (embedded on the DVD or available online).

Block 160 may represent a proprietary slot enabled DVD player that enables slots and supports playback without slots of legacy DVDs, playback with slots of standard advertising enabled DVDs, playback with slots of its own proprietary slot enabled DVDs, playback of proprietary slot enabled DVDs from a competitor. When it supports playback of proprietary slot enabled DVDs of others it will try to find standard slot information (embedded or online) and play auxiliary content (such as advertisements) using that information failing which it will play the DVD without slots.

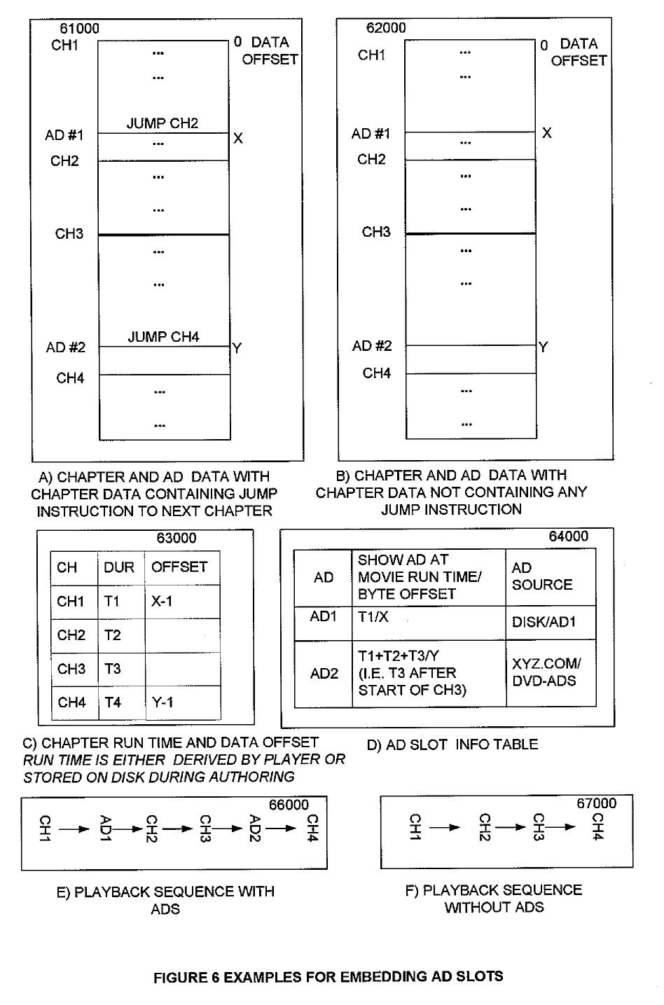

FIG. 6 shows exemplary data layout schemes for embedding advertising information. As shown, chapters of content or advertising may be stored in one or more files on the DVD. FIG. 6 at part (a) (block 6100) shows one exemplary DVD data layout for embedded advertising information. This layout may be compatible with legacy players in the sense when played back by a legacy player the embedded advertisements may be shown.

FIG. 6 at part (b) (block 6200) illustrates an alternate DVD data layout for embedded advertising information. This layout avoids any impact to legacy DVD players from embedded advertising information and advertising data.

FIG. 6 at part (c) (block 63000) shows chapter run time and data offset for each chapter and this information can either be explicitly stored on the disk or inferred by the player from reading DVD meta-data, such as a video management information table—VMGI_MAT on a standard DVD or a playlist on Blue-Ray DVD.

FIG. 6 at part (d) (block 64000) shows advertising slot information where each advertising entry has parameters including advertising id/name, slot time location (relative to movie run time), and source of content for the advertising slot. Information in each advertising slot can specify relative time from start of the movie or reference other points within the movie.

FIG. 6 at part (a) can also show jump instruction in the data. This is so that when a legacy DVD player is playing a DVD that is authored with advertising slots, the player can be made to avoid playing the advertising slots using such methods as jump instructions in the data stream or other technique/schemes as may be allowed by DVD technologies to specify a jump. If a legacy DVD player does not support jumps (or other techniques) then the user may see advertisements.

In the example layout shown in FIG. 6 at part (a), Ch1 data contains a jump instruction at the end of that chapter to instruct player to jump to Ch2 and another jump instruction at the end of Ch3 to skip Ad2 and jump to Ch4. For a legacy DVD player that supports jump command the effective play back sequence will be Ch1→Ch2→Ch3→Ch4 as shown in FIG. 6 at part (e). For a legacy DVD player that doesn't understand or ignores the jump instruction, the effective playback sequence will be Ch1→Ad1→Ch2→Ch3→Ad2→Ch4 as shown in FIG. 6 at part (d).

In general, a DVD Player may implement advertising slots as follows: it first obtains advertising slot information embedded on DVD, for example, in a file or some proprietary area of the DVD—such as burst-cut-area (BCA). The information may be organized as per embodiment shown in FIG. 6 at part (d). Next, it will construct playback sequence as shown in exemplary example in FIG. 6 at part (f). It will, if necessary, modify data stream so as to erase jump instruction (or other such embedded technique to imply a jump), if any, placed at the end of movie chapter/segment preceding each slot. If an advertising slot requires getting data from online then it will connect to online server to fetch advertising. The fetching can be done in a batch, for example, at the start of the DVD or progressively or based on some heuristics.

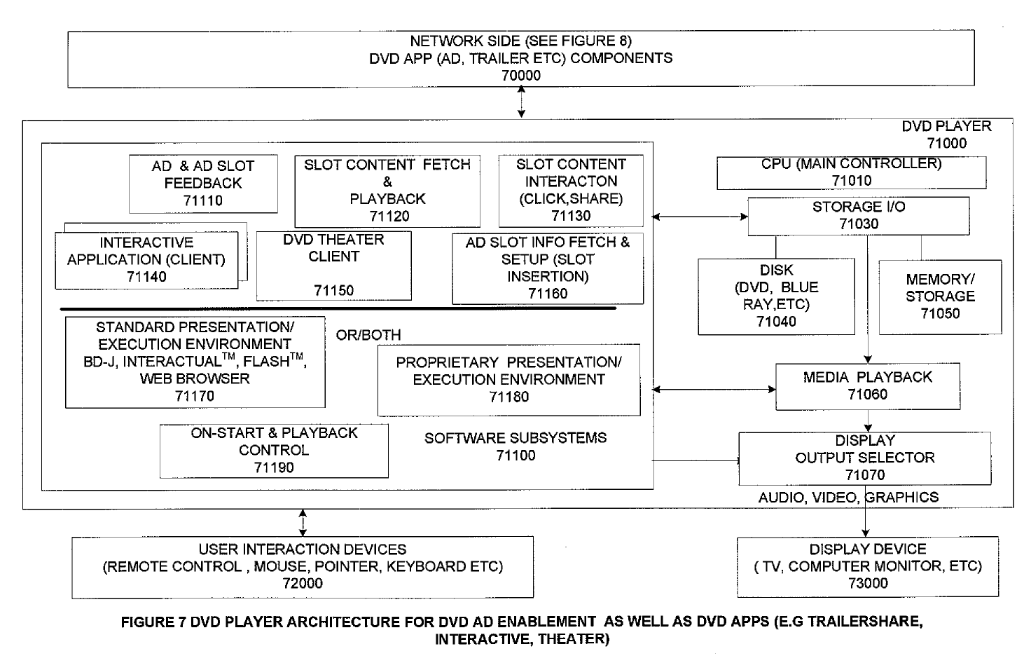

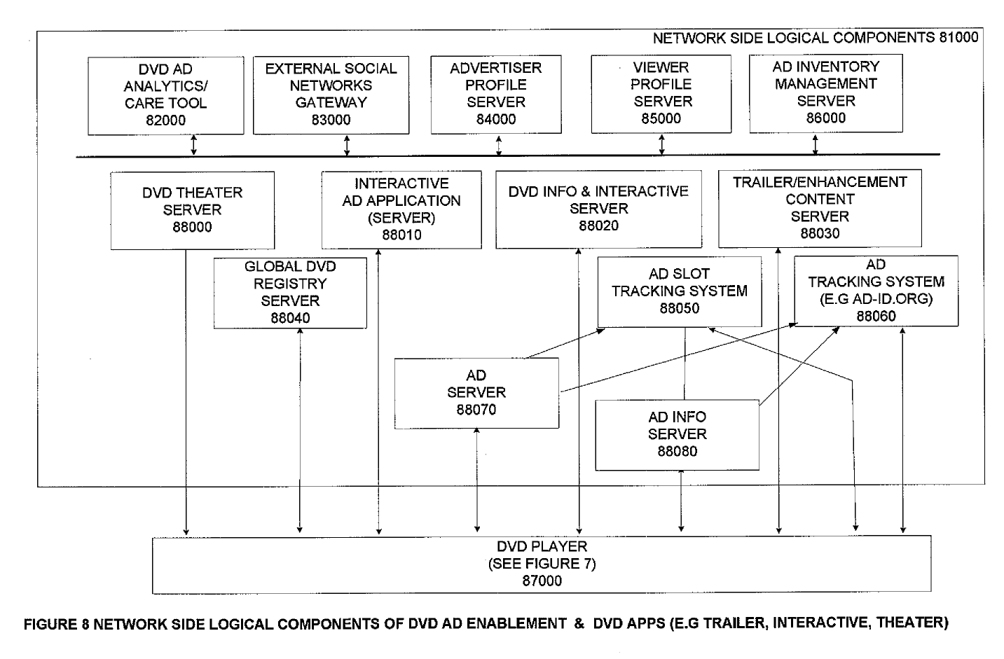

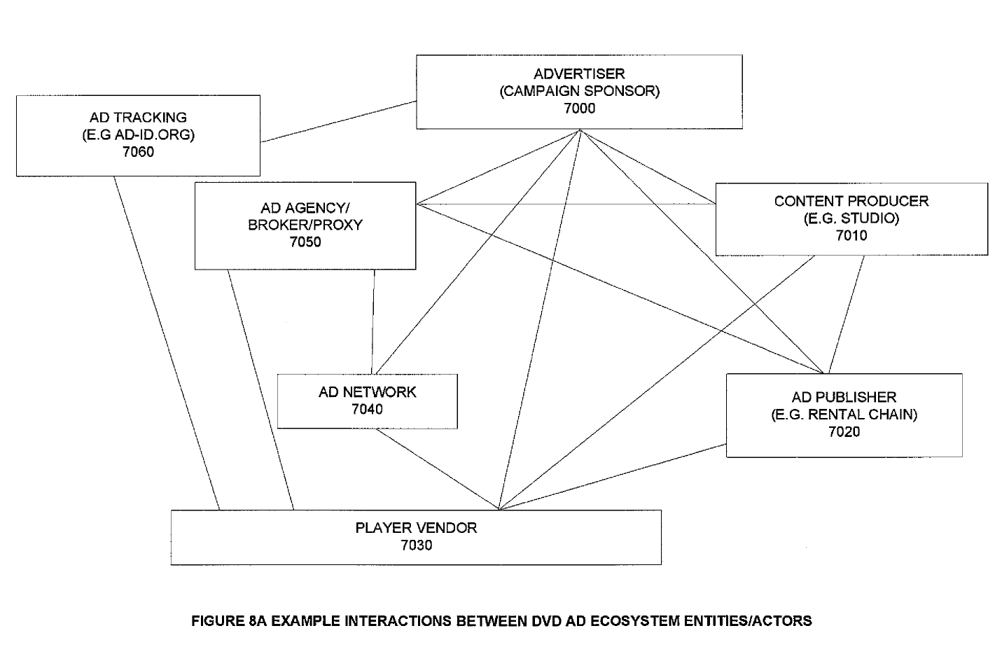

FIG. 7 shows a possible architecture of a DVD player that supports advertising slot. FIG. 8 is provided to show possible interactions of such a player with network side components.

Block 71010 represents a main controller that executes basic player control software as well as code related to enabling DVD advertisements and interactive DVD viewing related software subsystem shown in block 71100.

Block 71030 represents storage I/O functional module that supports reading/writing to storage media where storage media may be realized using read/write memory or read-write DVD disks, read/write CDs, read-write hard disks or any combination of these.

Block 71040 represents disk type storage media like CD, DVD, and Hard disk. Block 71050 represents semiconductor type of memory like RAM, ROM, Flash memory etc. Writeable media can be used to store fetched content as well as meta-data, e.g. a Blue ray play list that is manipulated to create slots at designated points in time.

Block 71060 represents media playback and includes decode processor to decode given video stream to derive display output. Fetched video content for one or more slots is provided to media playback module for decode and display.

Block 71110 represents logical software module that provides feedback on advertisement (auxiliary content) viewed in a slot to one or more network systems as required by the advertisement (auxiliary content) shown. This block also provides feedback when an auxiliary content slot is used by way of interrupting the main content and playing designated auxiliary content in that slot. The feedback is sent to one or more network systems as required by slot information.

Block 71120 represents functionality used to fetch video content for a given video slot as specified in slot details as well as setting up player such that fetched content is accessible by media playback (71060) block for decode and display. Fetched content is stored using storage I/O block (71030).

Block 71130 contains functionality associated with enabling interaction with content shown in slots. It supports click functionality that may result in directing viewer to interactive application associated with the content that was clicked.

Block 71140 represents one or more interactive applications that run on presentation/execution environment provided by the player. A given interactive application can be used associated the main content or content of a slot.

In some embodiments, interactions can be enabled by online DVD applications supporting advertising slots in the DVD. For example a DVD player can, at the end of a movie or at any time during the movie, run an application that lets user rate the movie or comment on the movie. Such feedback can be posted online to sites, e.g., on the Internet. Another example is an interactive application that allows a user to perform a virtual return of the current DVD or add one or more movies into the rental queue including watching trailers of upcoming or older DVDs when starting a DVD or as the DVD is finishing playback of a movie. Another application may allow a user to click DVD advertising anytime during the play.

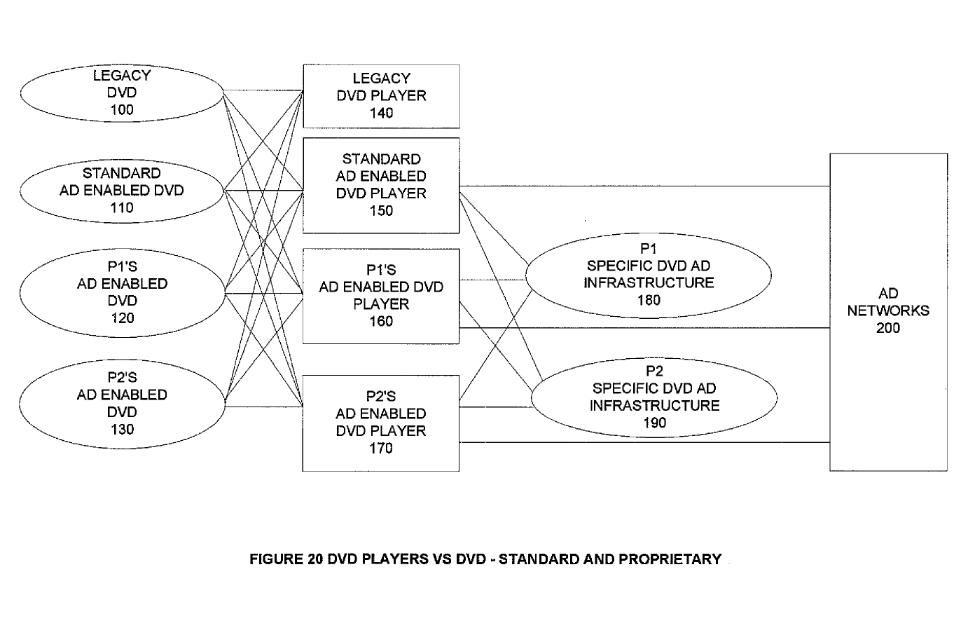

Block 71150 represents DVD Theater client module that provides functionality required to allow viewer to participate in DVD Theater. This module interacts with or may be part of a DVD Theater server application component (such as shown in FIG. 8) on the network side. The module may present to viewer a list of available shows for the digital content being played back (whether using DVD or file downloaded or VOD stream) and allow the user to join a theater show that is in progress or about to be started. FIG. 20 also illustrates an exemplary view of entities involved, including viewers, in theater viewing of a DVD.

Advertisements can also be played while playback of the DVD is paused or stopped. For example, if a group is watching a DVD and one or more group members need to take a call or need to attend to something, typically the movie is paused. In some embodiments, during this time rest of the group may be shown one or more advertisements from various advertising slots. In general, playing of advertisements during a pause or stop can be enabled on DVD players as soon as pause/stop is pressed or after a pre-determined period of time, such as 30 seconds. Advertisements played can be fetched from online sources before or after pause button is fetched.

Alternatively, the advertisements may originate from one or more of the embedded advertisements, or online advertisements fetched previously may be reused. In general playing advertisements during a pause/stop can be performed in addition to showing advertisements at pre-determined slots in the DVD movie as described above.

The module can also process content skips to ensure the user is not behind or ahead of the rest in the theater. In case the user skips an advertising being shown in a slot, an alternate advertising may be shown in that slot until the slot is fully played for the duration it was designed at which time playback of main content continues. The alternate advertisements may be shown partially or fully depending when the previous advertising was stopped and replaced with the new one. For example if an advertising shown is 30 seconds in duration and after 5 seconds one viewer attempts to skip that slot, then an alternate advertising may be fetched that is also 30 seconds. According, at least 25 seconds of the advertising can be shown.

Block 71160 represents a DVD Advertising slot fetch and setup and may be referred to as a slot insertion. This block represents the actions by the player so that playback is interspersed with content for the various slots.

Block 71170 generally represents a presentation/execution platform or environment that can be used for running DVD presentation and interactive applications. For example, the platform could be based on Flash™ from Macromedia™, Interactual™ from SonicSolutions™ or BD-J from Blue Ray specification, standards based HTML Web Browser (e.g. browser that implements HMLT 4.0 including JavaScript support), or other known standard. Any of the functional blocks discussed earlier can be implemented to run on one of these standard platforms.

The presentation/execution platform can also be a proprietary platform with one or more of the functional blocks mentioned in FIG. 7 implemented to run on such proprietary environment. It is also possible for both types of environments to be available on the player with some of the functional blocks/applications implemented to run on standards based platform and the rest on a proprietary platform. In other words, a proprietary platform could be semi-proprietary or completely proprietary. A semi-proprietary platform may be based on platforms such as PlayStation™, Xbox™, etc. These are proprietary platforms, but known to third party gaming application developers and hence may be considered semi-proprietary. Advertising slot insertion and advertising interaction (as well as non-advertising interaction) can be implemented on any of these types of semi-proprietary platforms.

Advertising content interaction in these slots may be appealing to developers. For example, it provides additional opportunity to console game developers. In general, a content distributor, such as a rental chain or seller may distribute DVD players with a proprietary platform with software on it to support playback interspersed with advertisements as well as support applications such as interactive content, DVD Theater etc.

Block 71170 represents an on-start and playback control module and may include such functions as responding to disk tray open (eject) press requests, setting up disk I/O (71040) upon disk insert, setting up media playback (71060) and others depending on the needs of the various functional blocks and applications.

FIG. 8 shows logical components on the network side that can support DVD Advertising enablement as well as DVD Apps (e.g. Trailers, DVD Theater, and DVD Interactive). It also shows connections between the components and the DVD Player (block 87000).

Block 88030 represents module that supports serving content into slots designated for trailers, serving enhanced or additional content into slots designated as replacement content slots. This functional block may also support interactivity with the content served including allowing viewers to initiate sharing the content from DVD viewing session. In realization this block may be realized as multiple servers each offering sub set of functions associated with this logical block.

Block 88040 represents module that provides, per DVD title, address of slot information server (88040), address of DVD Information and Interactive Server (88020) and other application servers that might have registered with it. It thus acts as a registry server. This block can be operated by a consortium or by an organization that has backing of content owners, distributors, etc. Each DVD player that implements this disclosure may be shipped, in one embodiment, with pre-programmed (i.e. hard coded into the player) address of the registry server so the player can contact registry server at that location. Alternatively, the registry server information may be embedded on the medium used to distribute digital content. For instance, on DVD medium it can be in an area that the player understands based on pre-built logic in the player, in an area that is told to the player through setup by end user. It is also possible for player vendors to instruct end user to specify registry server and such information may be distributed to end user via installation/setup manual as is common when player is provided to user after purchase or download (in case the player is a software based realization such is common on Personal Computer based DVD players).

Block 88020 represents an optional module that provides functions associated with hosting and serving DVD specific information such as interactive content, ratings, statistics, etc. Interactive content includes such things as comments, ratings. It may contain address of application servers associated with a given DVD. Some or all of these application servers may also be registered in registry server (88040). Given this, a given DVD player (87000) can contact DVD Information and Interactive server (88020) to get contact info of DVD Theater server for a given DVD title. The concept of DVD Theater is further explained in other parts of this disclosure.

Block 83000 represents an optional module that provides access to social networks, such as MySpace™, Facebook™, Bebo™, LinkedIn™, iReachable™, etc. to get users' information needed for one or more DVD applications. User's information may include list of friends, status of one or more friends, etc. It may also include a mechanism to automatically set viewer social network status to ‘Watching Movie’ and depending on privacy settings of the viewer, set location of watching as well as the title being watched into the status (e.g. watching ‘Iron Man’ at home’). It can also periodically update viewer's status to include particular portion/chapter title of the DVD being watched. It can also post to the user's profile, at one or more social networks, shareable portions upon explicit action by user. Also, content owners, can post trailers, if the user allowed permission for content owners to do so, on user's profile following viewing of a particular movie/title or genre of movie suggesting others that might of interest to viewer.

Block 84000 provides profile of an advertiser as may be needed for advertising inventory management and advertising sale/auction process. Block 85000 provides profile of viewers as may be needed by advertising server (block 88070) for finding matching/targeted advertisements as well as to provide other services (by advertising server or interactive server or online applications) based on past history of titles rented, purchased, viewed, advertisements viewed, skipped, clicked/interacted, date and location of rent, purchase, etc. Such information may be helpful with serving relevant advertisements by advertising server (block 88070) and providing an interactive experience by servers 88010, 88020, 88030, which may include showing self comments on a movie recently watched, comments of anonymous as well as friends on a movie, view a history of self and friends, as well as a history of advertisements watched, history advertisements clicked, etc.

Block 86000 provides inventory management functions for content slots and advertisements to be shown in one or more slots. The system includes a data store of content slots; data store of auxiliary content (advertisements being one type of auxiliary content); marketplace and tools to sell/bid slots; tools for advertisers to manage their advertisements and set preferences and targeting rules; tools to ad publishers (the content owners) to manage their slot inventory and fulfillment preferences and parameters; and the like.

DVD slot inventory management system manages the addition/deletion of content slots, auction/sale of slots. The following table shows an example organization of slot information maintained by slot inventory management system.

TABLE 1
Example Content Slot Information Records

| | |
|---|---|
| Slot ID | S1 |
| Slot Group ID | G1 |
| Slot Publisher ID | AP1 |
| DVD/Main Content Title | Dr. Seuss' Horton |
| | Hears a Who (2008) |
| DVD/Main Content | 20th Century Fox |
| Provider ID | |
| Slot Duration | 30 sec |
| Allowed Auxiliary Content | Advertisement |
| | (possible: |
| | Advertisement, Trailer, |
| | Enhanced/Replacement |
| | Content, Copy |
| | Protection any) |
| Preferred Auxiliary | Video |
| Content Type | |
| Slot Rendering | Full Screen |
| Slot Dimensions | N/A |
| Acceptable | Web |
| Auxiliary/Advertisement | |
| Content Type | |
| DVD/Main Content Rating | G |
| Allowed | G |
| Auxiliary/Advertisement | |
| Content Rating | |
| Advertisement Targeting | None |
| Parameters | |
| Restrict | Violence, Adult/Porn |
| Slot Publisher Ref | |
| (for use by Slot Publisher) | |
| Exclusive To | Xyz |
| (e.g. slot is sold | |
| exclusively to some one to | |
| show their advertisements | |
| across all viewers of this | |
| DVD and the slot can't | |
| share advertisements from | |
| any one else) | |
| Assigned Advertisements | A100, A200, A500 |
| Content (in case slot is set | |
| for advertisements and | |
| where assignment is | |
| derived from sale/auction) | |
| Normal Price | 10000$/CPM |
| Premium Price | 20000$/CPM |
| Normal CPM Preference | 10,000$ |
| Exclusive CPM Preference | 20,000$ |
| Premium CPM Preference | 20,000$ |
| Exclusive CPM Preference | 40,000$ |
| PPC/CPC (Price Per | >3$ |
| Click/Cost Per Click) | |
| Preference | |
| PPA/CPA (Price/Cost Per | >10$ |
| Acquisition) Preference | |
| Preferred Advertisement | Finance/Home Loans, |
| Categories/Subcategories | Beverages, Theme |
| | Parks, Auto/New Cars, |
| | Medical/Diabetes, |
| | Auto/Insurance |
| Preferred Advertiser(s) | Xyz |
| Allowed Advertisers | xyz |
| (others are not allowed to | |
| advertise) | |

Similar to slot information, information for the auxiliary content can be maintained. An example record is shown in the table below for advertising content.

TABLE 2
Example Advertisement (auxiliary content) Information Records

| | |
|---|---|
| Auxiliary Content Type | Advertisement |
| | (other possible: Trailer, |
| | Replacement/Enhanced |
| | Content, Misc) |
| Advertisement Id | A100 |
| Advertiser ID | AD1 |
| Advertisement Duration | 30 sec |
| Content Type | Video |
| Content Rating | G |
| Content Parameters | None |
| Advertiser Ref (for use by | Ref1234 |
| Advertiser) | |
| Assigned to Slots (from | S1, S3 . . . |
| sale/auction) | |
| PPC/CPC (Price Per Click/Cost | 5$ |
| Per Click) Pay Off | |
| PPA/CPA (Pay per | 100$ |
| Acquisition/Cost Per Acquisition) | |
| Advertisement Category/Sub | Finance/Home Loan |
| Category | |
| Targeting: Viewer Preference | Age > 20+; Sex: Both |
| Targeting: Location Preference | California |
| Targeting: Time Preference | Premium |
| DVD Specificity | Any PG-13 |
| Studio Specificity | Any Sony Picture |
| Fill DVD Theater Slots first | Yes |
| before filling normal slots? | |
| Exclusive (can't share slots | No (can share with other |
| across locations, time, users, | advertisements) |
| DVDs?) | |
| Starts On | May/2008 |
| Ends On | June/2008 |
| Max/Target CPM | 0.5 |
| (Stop showing the advertisement | |
| after it hits target) | |
| External Tracking System | Ad-Id.org |
| External tracking ID | ABC12345678 |
| | (12 character code used by |
| | Ad-ID.org) |

The tables shown above are exemplary in nature. In general, the information supporting inventory management can be structured differently consistent with embodiments of the present disclosure. For example, possible options for advertising rendering may include full screen, split-screen, and overlay. If an advertising slot rendering is split-screen or overlay, then display area dimensions can be specified. For example, 0.125 H×W can mean that an advertising slot should be of ⅛ height of the full screen and width that of full screen. Location can be specified if needed. In case of overlay, additional information may be specified to help optimize overlay placement.

When an advertisement is purchased, it may be possible to set a budget limit for these purchases. For example, an advertising campaign may have target to reach 1M viewers. Once that target is achieved, the advertising can be taken off the chart. This allows advertiser to limit their budget and not have an advertising network operator charge advertiser more than their budgets allow. For example, if an advertisement has been served 100 times and has a budget for 100 views, then the advertising server may remove this advertising from the inventory to prevent it from being used further.

Block 88010 provides DVD Theater service functions, such as serving available schedules for a given DVD title, providing count of viewers in the theater where count may be measured across all, across a geographic area or across a given set of viewers, e.g. how many people in my social network are watching or how many people from my city are watching and so on, how many people above >30 are watching, how many singles are watching?, count or list of friends in the theater, managing advertising skips, and orchestrating the show and audience. Managing advertising skips may be utilized to synchronize viewing of the DVD by different users. For example, advertising skips can be handled by serving advertising until the advertising slot is finished. For instance, if the advertising slot starts in the theater and after 5 seconds some viewers attempt skip it, then those users will be served alternate advertising that is at least 25 seconds long. The alternate advertising can also be something like “Please wait while commercial slot is over.”

Block 80060 represents a player that performs playback of digital content interspersed with one or more content slots as described in this disclosure. At the start of playback it will try to find slot information or contact (i.e. online address) address of slot info server from the same source as the content. For example, when content is sourced from a DVD disk (standard as well as high definition variants) it will try to find slot information from the disk. Alternatively, if the content is sourced from one or more download files then it will check those files or a known file within those files for slot information. In case player is sourcing content form a VOD streaming channel then it will check or look for a known meta-information with in the channel stream. If it can't find slot information or address of slot information server by any of the above means then player will try to find contact (i.e. online address) information of DVD Registry Server (800030) and DVD Info server (80040) from the same source as the content as explained above. In case it can't find address of Registry or Info Server then the player may try to connect to a pre-programmed DVD Registry Server.

If it is able to find address of Registry server (80030) then it will contact the same and query for address of Slot Info Server for the content being played back. If this fails and if it has the address of DVD Info Server then it will contact the same and query for the Slot Info Server address. If both fail then it will either playback without interspersing with slots or prompt user to enter address of Registry Server or that of Info server or that of slot info server depending on how player vendors packages software to prompt user or directs user to setup player during installation or subsequently. All the options are possible to take advantage of services offered to users and benefits to the DVD value chain in enabling advertisements and other auxiliary content in slots.

Once a player has discovered address of slot information server it contacts the same and queries for slot. After obtaining a slot table, it proceeds to setup playback so that advertisements and other types of auxiliary content can be played at designated times as specified in the slot table thus obtained. The playback setup can be specific to DVD technology. One example involving Blue-Ray playback setup will be presented to explain the setup process. One skilled in the art will recognize that this example is exemplary in nature and therefore any alternate way of realizing the setup should be considered as within the spirit of this disclosure. Similarly playback setup of standard DVD player can be derived from this example and the rest of the description.

FIG. 8a shows possible entities involved in a DVD advertising ecosystem and possible interactions between them.

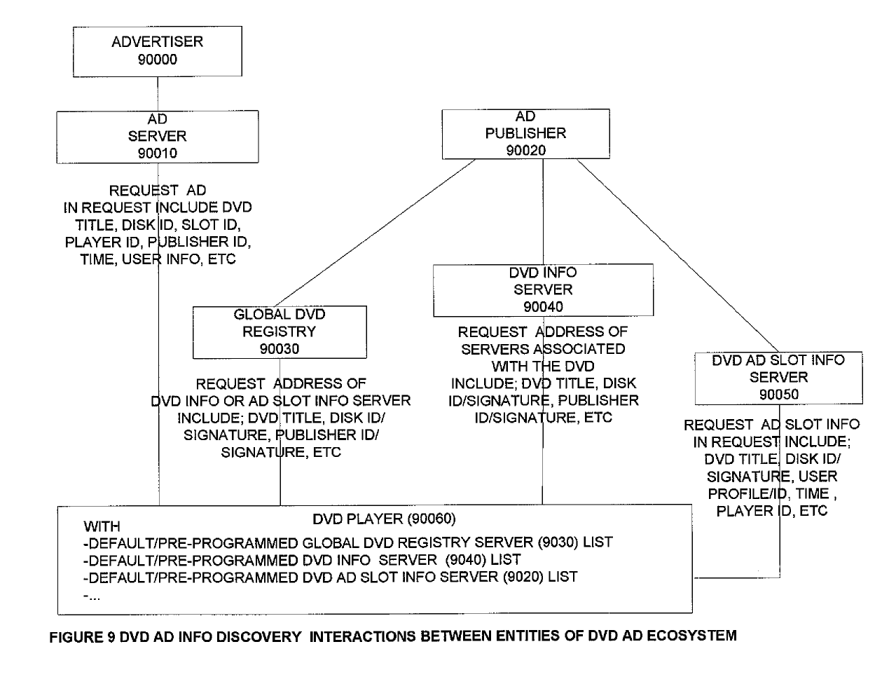

FIG. 9 illustrates interactions involved between some of the DVD advertising system for an advertising information server discovery process. Player (80060) upon start and upon reading DVD information from the disk (or from one or more files in case of playback from downloaded files; or from meta information in case of playback from a VOD stream) determines if it has ad slot information. If it doesn't then it will see if it can find DVD specific info server (80040) contact info from the disk. If not it will see if it can find contact address of DVD Info Registry server (80030) from disk failing which it will try to connect a pre-programmed DVD Info Registry Server. Once address of DVD info server (80040) is obtained from the player connects to it and obtains address of Ad Info Server (80050) to which it connects to get ad slot table specific to that DVD.

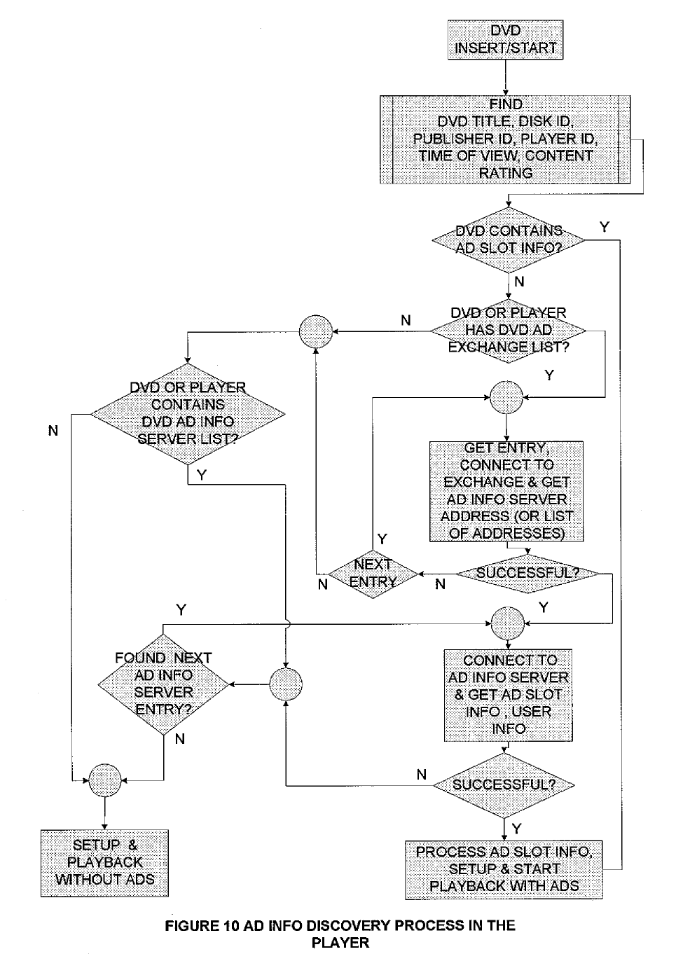

FIG. 10 illustrates exemplary ad info discovery process in the player.

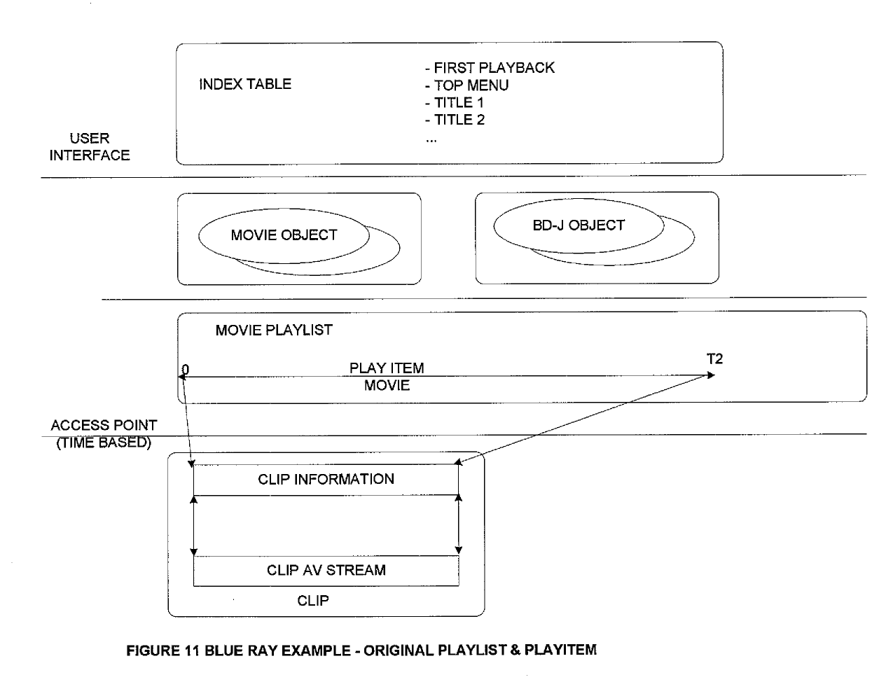

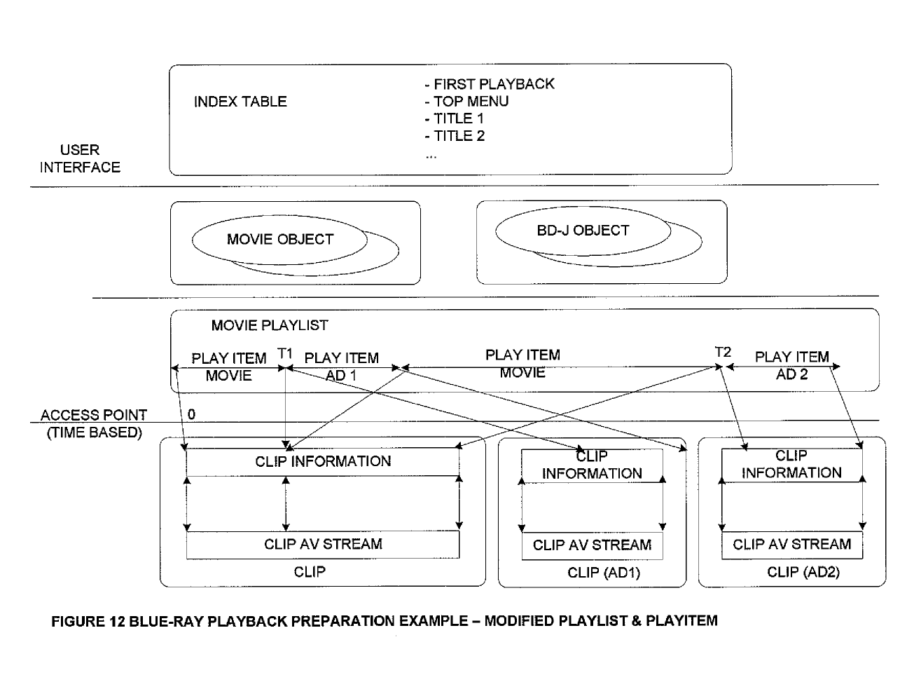

FIG. 11 shows example Blue-ray DVD playlist (original) where main content (movie) runs from time 0 to t2, and the movie consists of one clip. To support two advertising slots at t1 and t2 respectively, the original play list is replaced by 4 play items: a first one to play the movie clip from 0 to t1; a second play item to realize advertising slot a1; a third play item to play movie from t1 to t2; and a fourth play item to realize advertising slot ad2 as shown below. FIG. 12 illustrates the modified play list.

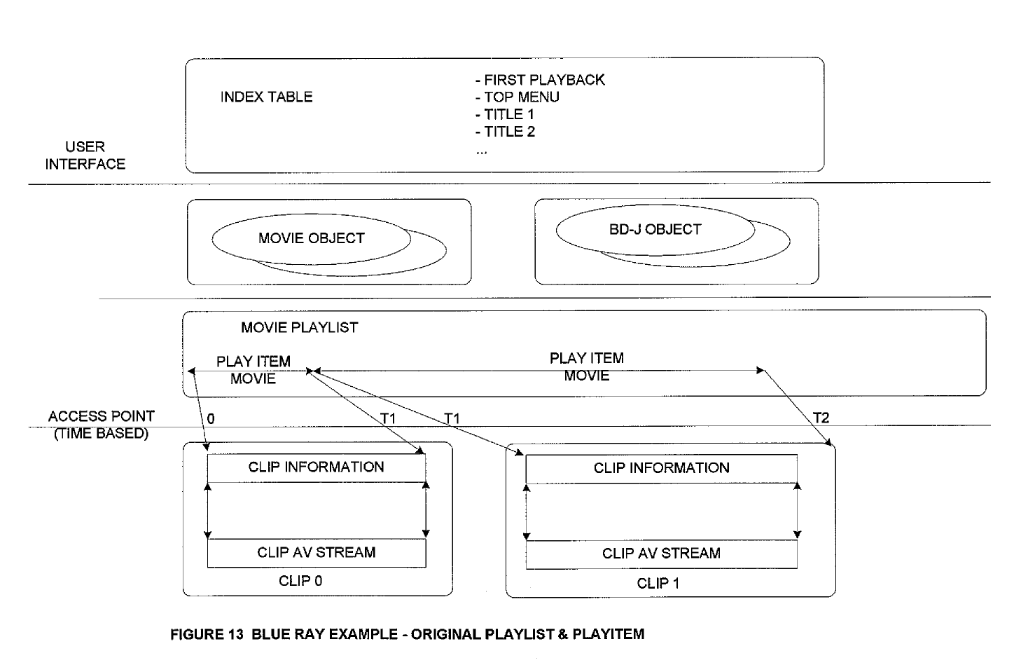

Another way to realize advertisement slot insertion is to create data tree in memory to represent play list for advertisements and merge it with the original tree associated with the main content, e.g., the movie, to determine a final tree as shown below. For this example, the original content has two clips (0 and 1) and a playlist comprising of two play items as shown in FIG. 13.

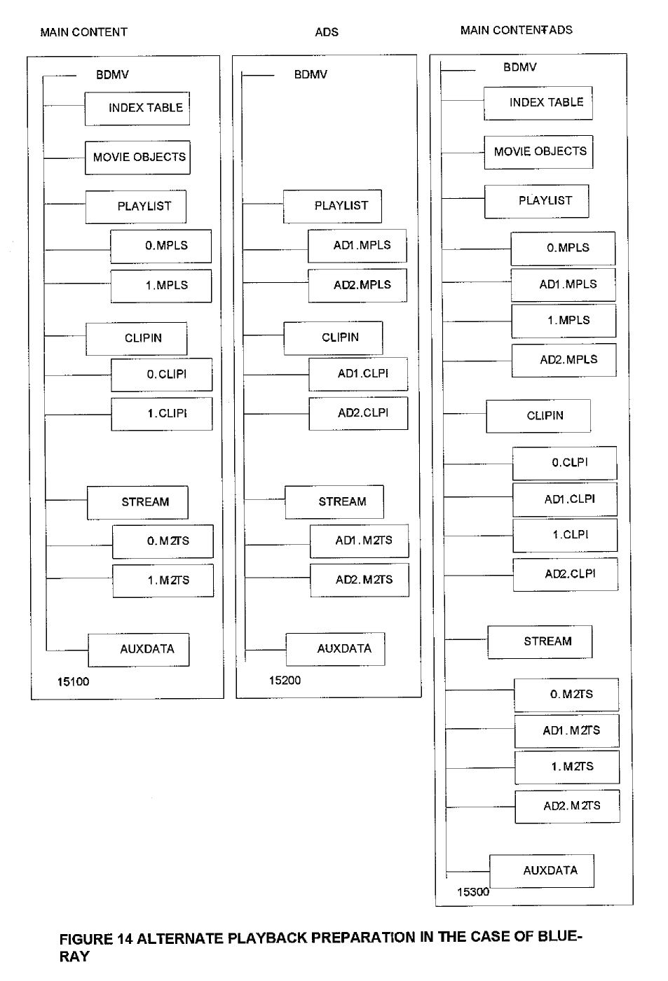

FIG. 14 illustrates merging of play items for advertisements and main content to create a new playlist tree. As shown, block 15100 shows original playlist and associated elements (CLIPIN, STREAM). At block 15200, a play list for advertising slots and associated elements (CLIPIN, STREAM) are shown. At block 15300 a merged playlist and associated elements are shown. Slot publishers can set up slots at the time DVD/content is added into the inventory management system. Alternatively, they can set up rules so that slots can be created at the time of sale/rent or actual viewing of digital content/DVD. The rules can use parameters such as genre, content rating, viewer profile (as may be available from POS/POR) or from player. For example, if a user of age group 50+ is watching a given DVD then a rule may specify that the system shall create 8 slots and provide a slot table to the requesting player. Another way to customize a number of slots may be based on viewing history. For example, if a player requested advertising slots information when viewer is watching a given DVD second and subsequent times, then the slot information server can send slots placed differently and more leniently compared to first time viewing. Even if the number of slots, and slot lengths are identical, slot locations can be different or ads and other auxiliary content shown in one or more slots can be different. For example, if the slots are ts1, ts2, ts3, ts4, ts5 on one request and the advertisements played are a1, a2, a3, a4, a5, then on a separate request for the same DVD and for the same viewer the slots could be ts1, ts3, ts4, ts5, and the advertisements played could be a5, a4, a3, a2. In other words, one slot is dropped, one advertisement is dropped, and some advertisements were played before the others. The order of advertisements played on different viewings of a given DVD by same viewer or other viewers may be based on various factors, such as, whether a given advertisement has more CPM compared to the time of first request. Ability to play different advertisements on subsequent viewings as well as moving advertisements from back end slots to front end and vice versa allows an advertising network to continuously optimize advertisements served based on advertising pricing. In general, the ability to customize placement of slots as well as advertisements shown in those slots per viewer and per DVD provides flexibility to DVD advertising value chain.

A content slot publisher can update DVD slot information any time after entering the DVD into inventory management system. Updating slot information related to a DVD can involve deletion of one or more slots, change of slot's location in the movie, duration, pricing, allowed list of advertisers, allowed auxiliary content, content type, and any other parameters associated with slots. Global information such as slot info server, address of Information & Interactive server and so on can also be updated at places where they are maintained. When a slot is to be removed, a check can be conducted for any advertisements already sold against that slot. If yes, then an option to keep the slot may be provided to the slot publisher. The publisher may then decide to keep the slot or provide credit to advertisers or let CPM and other metrics resolve the payments.

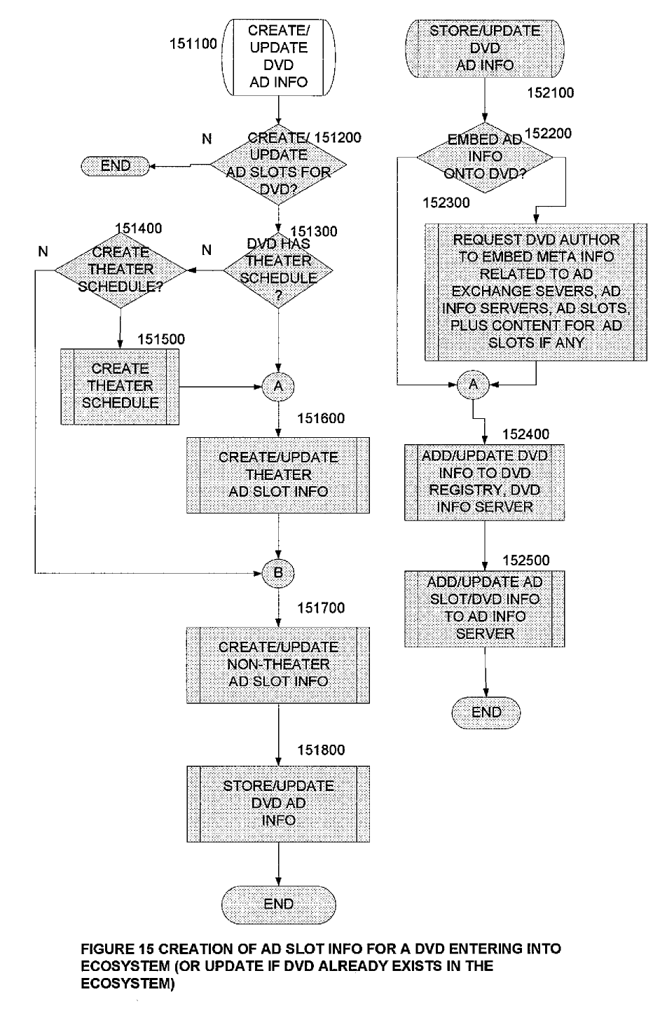

FIG. 15 shows an exemplary process, which may execute in advertising inventory management server shown in FIG. 9, for creating slots for a new DVD or updating slot information of an existing DVD entry in the inventory management system. The process starts by checking, in step 151100, if a slot publisher wishes to create/update slots for the DVD. If yes then the process further checks, in step 151200, if the DVD has any theater playback shows scheduled. If none exist, then it allows, in step 151300, creation of one or more theater playback shows. If one or more theater playback shows exists, then the process proceeds to create/update information associated with the DVD. In step 151400, slot information for theater playback is shown. Slot configuration can be setup for a specific show, for a set of shows, or for all shows. Inputs may also be received, such as number of slots per show, slot location in the movie, slot duration, allowed auxiliary content type (video, web, game, etc), allowed auxiliary content rating (PG-13 etc), pricing, etc. Pricing information may depend on how slot publisher wishes to package and sell DVD theater advertisement slots, such as price per slot/day or slot/week, slot/region, etc. Pricing can also be based on number of viewers in the theater. For instance, for 0-100 viewers, the slot price may be $X. However, for 101-500 viewers, the slot price may be $Y, and other such variations.

Next, in step 151400, information is prepared for addition to DVD Registry and DVD Information & Interaction servers. Information to be stored at DVD Registry can include the address of the DVD Information & Interactive server and, optionally, a DVD Slot Information Server selected for that DVD. Information to be stored at DVD Information & Interactive Server can include the address of DVD Slot Info server and other application servers involved in providing various services associated with the DVD. Though one DVD Slot Information server may be sufficient to serve slot information for a DVD, multiple slot information servers may be used for load-balancing or for reliability purposes. Multiple slot information servers could also be used to allow localized serving. For instance, DVD playback in one region may be associated with one slot information server designated for that region while the same DVD when played in another region may be associated with a different slot info server. To provide flexibility, the disclosed embodiments thus allow storing, at DVD Registry, addresses of one or more slot information servers for a DVD.

Next, at step 500, Slot Information server (or multiple servers) may be updated with the details of created/updated slot information.

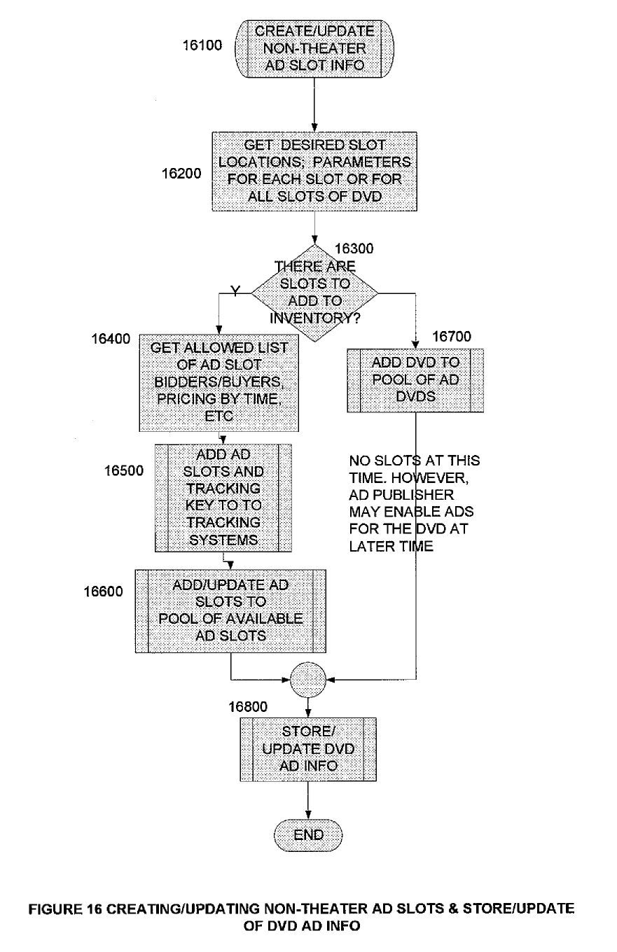

FIG. 16 shows an exemplary process, which may run in advertising inventory management server shown in FIG. 9, for Creation/Update of non-theater advertising slots for a DVD. In step 16100, the process receives inputs, such as number of slots, and parameters for each slot (duration, allowed content type, etc). Next, in step 200, a check is made if there are slots to be added.

If there are no slots configured at this time then it will add the DVD to the list of DVDs available in the ecosystem. Slot publisher can configure slot information at a later time.

If a DVD has slots, then the process, in step 16400, gets a list of allowed advertisers, pricing information etc form the slot publisher (whose is creating/updating slot information). It also may get a list of slot information servers that will serve slot information for that DVD. Next, in step 16500, tracking information for each slot is taken from the user who is configuring the slot. In various embodiments, a tracking id can be associated with each slot. For example, after a slot is played, a DVD player may contact one or more external tracking systems associated with the slot and update its statistics. These statistics may allow entities, such as slot publishers, to see which slots have actually been played and how they are performing.

In step 16800, information for each slot is sent to slot information server which stores it for later use or by stored directly into data store used by slot information server.

The disclosure also enables new forms of DVD movie rental process as will be explained below. In particular, this disclosure envisions, by using slots, a tracking framework to allow DVD players to detect when a user has watched a movie. In response, the DVD player may send an event to indicate ‘end-of-view’ to a rental store, etc. The rental store can then mark that DVD as ‘finished-watching’ and update the available inventory of that movie. Not only that, the rental store can ship the next DVD that is in user's queue. In case the consumer continues watching a DVD after it has been marked as ‘finished-watching’, then viewing of that DVD can be interspersed with more sots carrying advertisements or other auxiliary content than before. This feature may be useful in encouraging rental chains to allow users to keep DVDs that they've rented. Alternatively, the disk can be made to expire with a certificate that gives a start time and a few days after ‘finished-watching’ event. Alternatively portions of movie can be encrypted that can't be decrypted after a ‘finished-watching-event’. One skilled in the art will recognize variations of this may be used to optimize user experience and realize feasible and economical player implementation and rental business models.

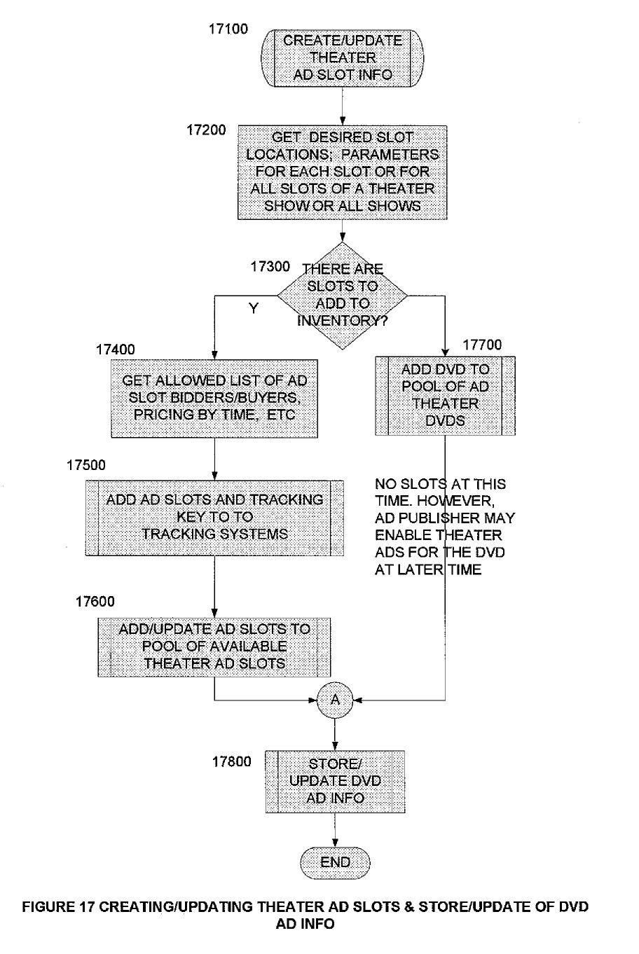

FIG. 17 shows an exemplary process, which may run in slot inventory management server shown in FIG. 9, for the creation or updating of slots for a theater showing of a given DVD. The concept of DVD Theater is explained in FIGS. 20, 21 and 23.

In step 17200, the process determines desired slot locations, parameters for each slot or group of slots. Parameters may include slot duration, allowed content type, allowed advertiser list, allowed advertising content ratings, and other parameters. Data for matching and targeting rules may also be determined at this step.

In step 17300, a check is made for any slots to be added to inventory. If not, then, in step 17700, the DVD is added to a Theater DVD pool so that at a later time an advertising publisher can access the DVD and revisit the advertising slot setup for that DVD. If there are slots to add to the inventory, then, in step 17400, determines the allowed advertisers, pricing details and other such details per slot or group of slots. Next, in step 17600, advertisements for the slots are added to the pool of theater advertising slots. All the information accumulated is then pushed to various servers (registry server, information server, etc.).

The present disclosure also provides methods for advertising inventory fulfillment using a concept called active slots. Once a DVD is bought or rented, advertising slots for that DVD can become active. These slots can also be attached with a viewer profile based on information available from the Point of Sale (POS), such as, when the DVD is purchased at a store like, Costco™ or other places, or from the point of rental (POR), such as, when DVD is rented at Blockbuster™, or purchased from Amazon™, NetFlix™, etc.

Active slots represent an opportunity for advertisers and help manage allocation of advertising budget. For example, if an advertiser has a limited advertising budget, then costs for advertisements can be allocated first for active slots and then for non-active slots (called passive slots) across DVD, Web, TV, etc. Today, such allocation is not possible with online advertising since payments are made using CPM, PPC/CPC and other models that are after-the-fact in nature. In some cases, advertisers have been forced to buy inventory whether or not the inventory is actually shown to visitors. In contrast, an active slot inventory represents an improved prospect for an advertiser to allocate budget as it is very likely to be watched.

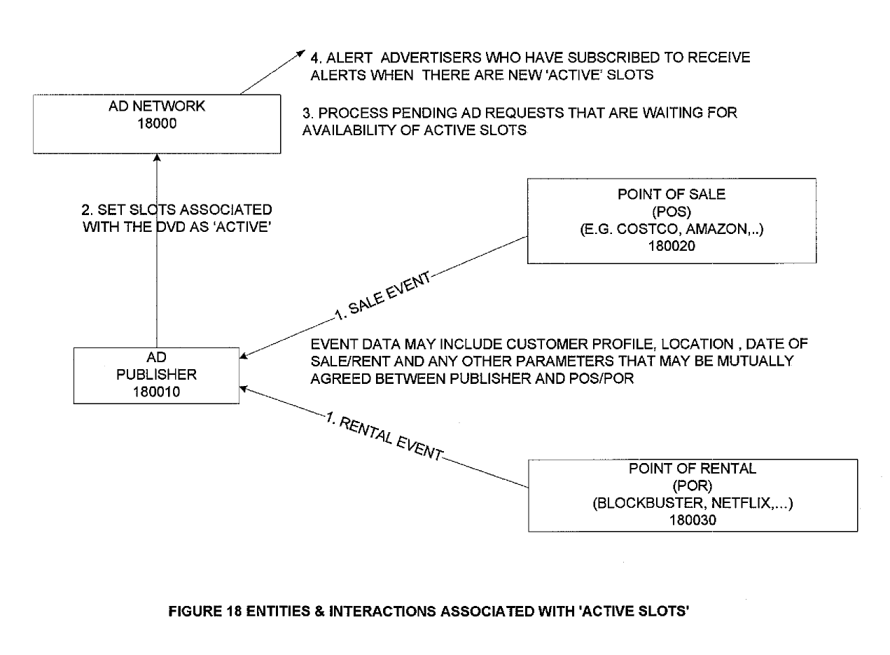

FIG. 18 also shows entities and exemplary interactions related to active slots, such as advertising slots of a DVD marked as active following rental/sale of that DVD ex explained above. The process starts at a POS (point-of-sale)/POR (point-of-rental) 180020 following purchase/rental of digital content by a consumer. POS/POR system then sends an event to the advertising network (owning inventory management responsibility) associated with the digital content that was sold/rented. Upon receipt of such event, the advertising network 181000 processes the event and sets slots associated with the digital content as active. It then proceeds to assign matching and waiting, if any, advertisements to the slots. The advertising network may also send fulfillment alerts to advertisers or advertising agencies/broker when any of their advertisements have been assigned. It can also send alerts to them when new active slots become available so that they can start finding matching slots on their own instead of relying ad network to find for them. In general this framework allows for automatic assignment of ads to slots by ad network based on set of rules/preferences set by advertisers and slot publishers. Similarly it allows advertisers, ad agencies/brokers to perform suitable slot search on their own and purchase/bid on those slots.

An embodiment of the present disclosure may enable a DVD theater. For example, Content distributors such as DVD rental chains or video on demand (VoD) service providers or others can package DVD theater offerings. DVD Theater, in this invention, involves putting together schedule for synchronized DVD viewing. Such viewing may bring a community of users together for watching the content (just like in a theater) and optionally enable interactions between viewers. When a DVD player that implements supports for auxiliary content slots per this disclosure and in particular DVD theater concept, plays DVD that is setup for DVD Theater then it can provide option to user to join a DVD theater or watch alone. If viewer accepts to join a theater then the player supports synchronized playback as well as offer community and content interactive features. Slot based advertisements and other auxiliary can be shown in a DVD theater similar to showing the same to single viewer. Enhanced advertisement tracking, ad slot insertion may be offered given the nature of theater viewing and its appeal for advertisers to show ads in the thus created slots. FIGS. 20, 21, 22 and 23 are related to DVD Theater and will be further explained in detail here.

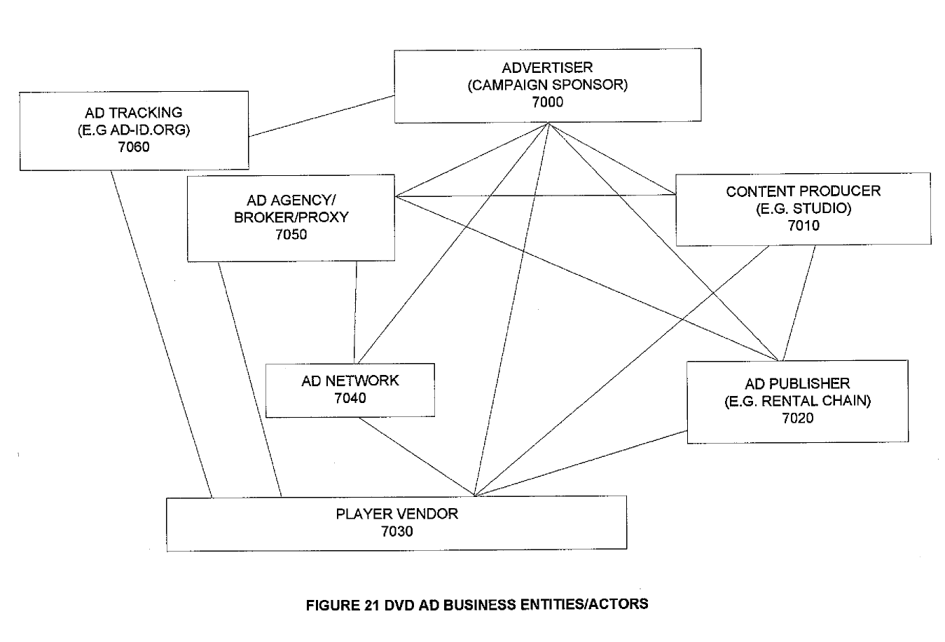

FIG. 20 shows entities involved in DVD theater enablement. Some of the blocks are repeated from FIG. 8 and explained as part of FIG. 8. The ones shown are specific to DVD Theater enablement. Block 20050 is the DVD Interactive server that enables user interactivity with the DVD content. It may also be the interactive server for auxiliary content shown in one or more slots. Block 20040 represents Slot Info Server that is responsible to serve slot information table to player on request and which has been explained earlier. Block 20030 represents functional module responsible for serving special content such as trailers, replacement/enhanced content for one or more slots and request from DVD player. Block 20020 represents Theater Server (also shown as block 88000 in FIG. 8) responsible for managing theater schedules for one or more DVD titles and user interactions associated with browsing schedules, joining/leaving theater and others as detailed in FIGS. 21, 22, 23 and in general one or more aspects described as part of Theater concept description in this disclosure. A theater server logical entity can provide means for content distributors (rental chains or others) to create theater schedule for a given DVD title (see some of the processes within this entity in FIG. 21). For example, one can create schedule for title x with theater shows starting at Fri/6.00 PM, Fri/7.00 PM, Fri/8.00, Fri.9.00 PM, Fri/10.00 PM, Sat/6.30 PM, Sat/7.00 PM, Sat/7.30 PM, and so on. When a DVD player starts playback of a title, it can check with ‘DVD theater’ server to see if there are any shows. If yes allow viewer to join one of the theater.

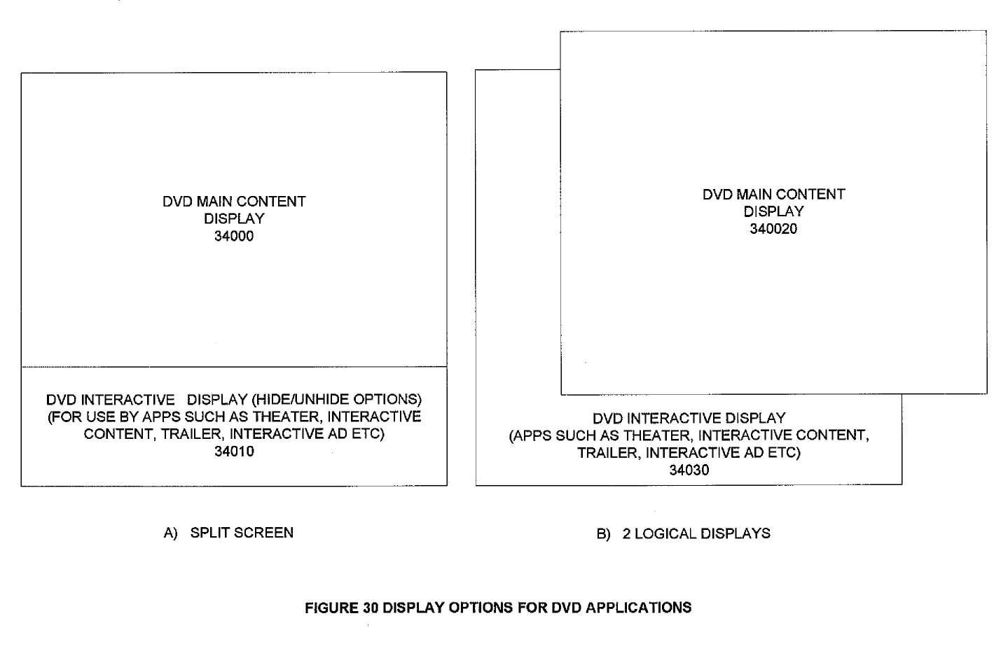

Watching a DVD in a theater is not simply to enable viewer to watch the content, but also to provide experience that is as close (or better than) to the typical physical theater viewing experience. The enhanced experience is made possible by theater interactions described in this disclosure. In general, DVD theater interactions can be grouped into two primary categories (variations can be easily conceived by those skilled in the art based on this disclosure): a) viewer to viewer interactions and b) viewer to content interactions. Viewer to viewer interactions can be 1-1, 1-n or 1-all. In 1-1 interaction a viewer interacts with another viewer, for example, two friends in a theater interacting with each other. In a 1-n interaction a viewer interacts with n others where n represents a subset of viewers in the theater. For example, a group of friends in theater interacting in a broadcast manner where what one says/does is heard or seen by rest of the group. In a 1-all interaction, one viewer interacts with all in the theater. For example, when a viewer writes a comment about something that happened in the movie or predicts about something to happen then such comment can be seen by all. Interactions can use smileys, comments, audio or pictures or video. Interactions, particularly 1-1, 1-n, can be related to the content or unrelated to the content. In general, interactions in theater between viewers (1-1, 1-n, 1-all) as well as with content can be displayed using two display options—split screen and dual screen option as illustrated in FIG. 30.

A theater viewer may want to forward, rewind, or pause playback. Similarly, viewer may want to skip an ad that is currently playing and such action can be equated to ‘forwarding’. In general, when a user takes action on playback (forward or rewind or pause) then the viewer can be reminded that he/she is in a theater and hence requested operation can't be carried out. If a viewer wishes to still proceed with the operation then he/she can be informed that it will result in leaving the theater. If that is acceptable to the viewer then the viewer will be removed from the theater. A viewer can be allowed to proceed with the operation outside the theater. Later, a viewer may rejoin theater and normal process for joining will be applied as illustrated in FIG. 21. It is possible for such viewers (who stepped out to carry out an operation) to get preferential join treatment than new viewers entering theater. In the case of forward or rewind, it is also possible for viewers to join other theaters that are behind or ahead of current theater. Essentially, they can hop from one theater to another if desired to do so. For instance, if there are theaters playing a movie at 15 minute intervals then if user forwards or rewinds current playback then he/she can see list of theaters where movie playback is aligned with his/her private playback. For example, assume a viewer forwards, after leaving a theater, by 15 minutes. He/she can be shown list of theaters that are 15 minutes ahead of the previous theater and allow the user to join one of them. In general, a viewer should be able to access list of theaters he/she can join without missing anything from his private watching. Player to viewer interactions for forward (including ad skip), rewind or pause may be realized multiple ways. For instance, DVD players can show from current playback position time-from-start, and time-to-finish. Along with such information, players can also show list of theaters aligned with current position so user can pick one and join.

FIG. 21 shows exemplary process flow involved in DVD theater application. The process executes on a server that acts in the role of DVD Theater server.

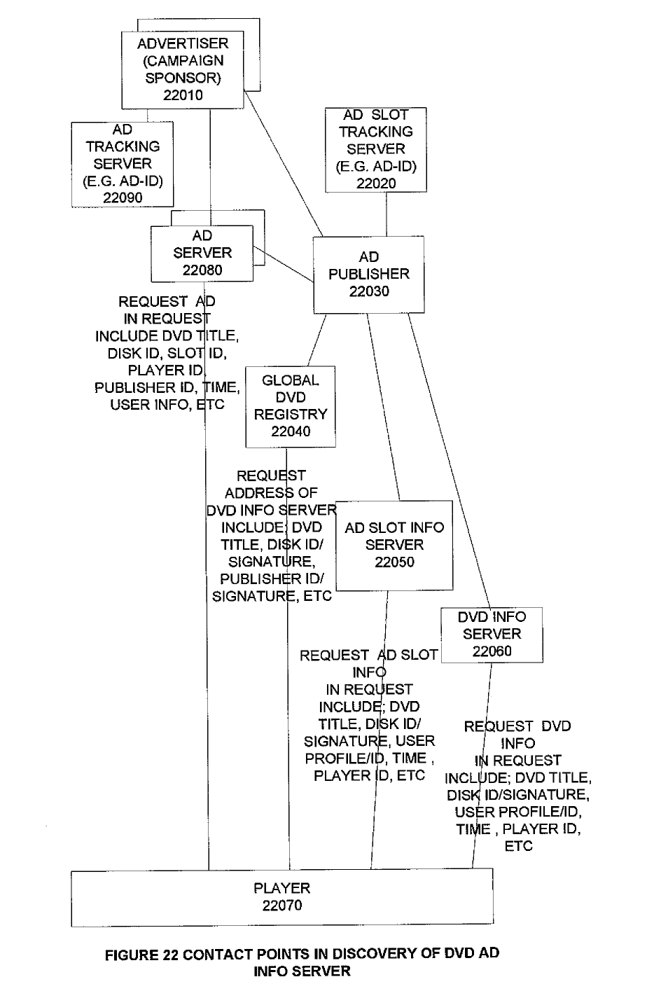

FIG. 22 is continuation of exemplary process flow involved in DVD theater application. DVD Theater related aspects and where the shown process runs in an application server acting in the role of ‘DVD Theater Server’.

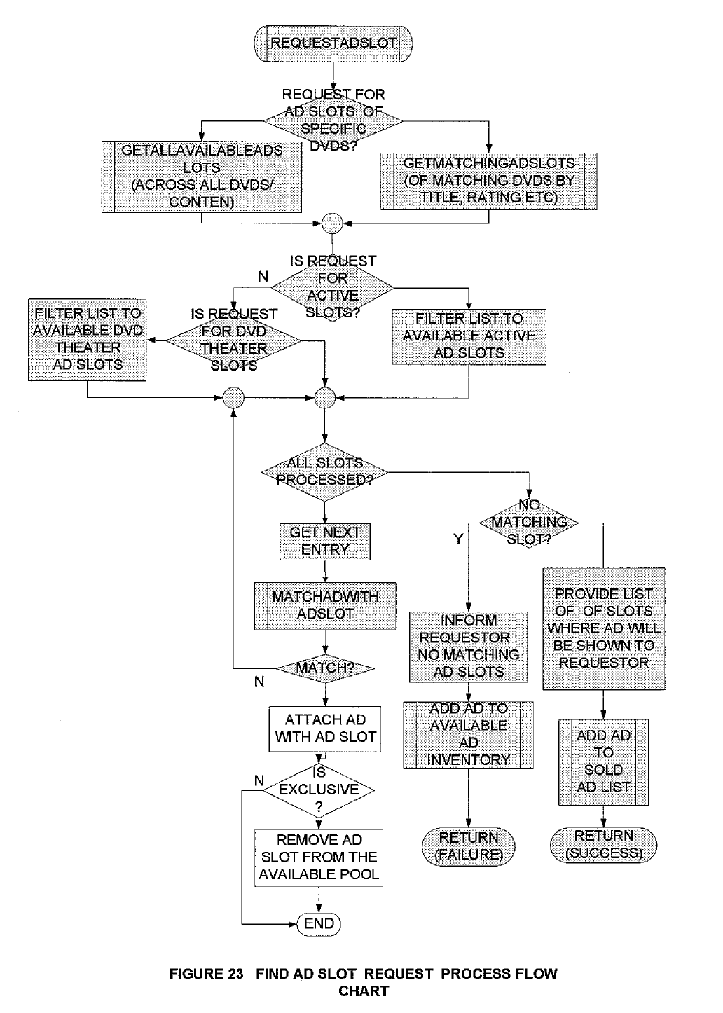

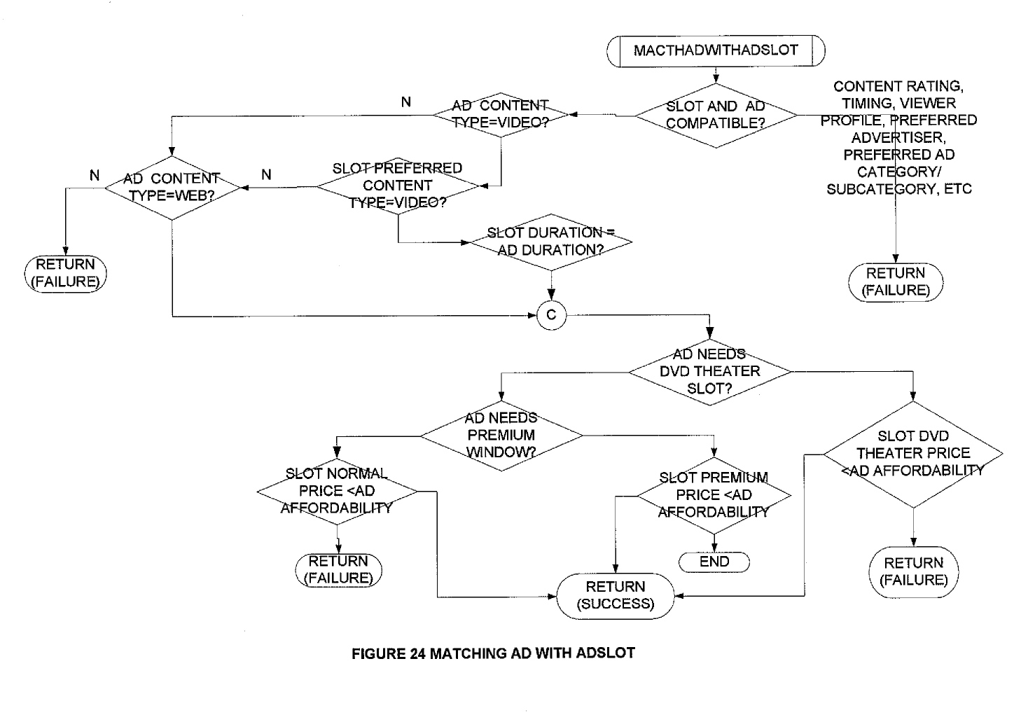

FIG. 24 shows a sub-process of main process described earlier (in FIG. 23) which checks, given an ad that has requirement or preference to be shown in DVD theaters, availability of one or more theater slots for the ad for which the process is executing.

FIG. 24 illustrates an exemplary process flow involved for finding matching advertising slot for a new advertising request from an advertiser.

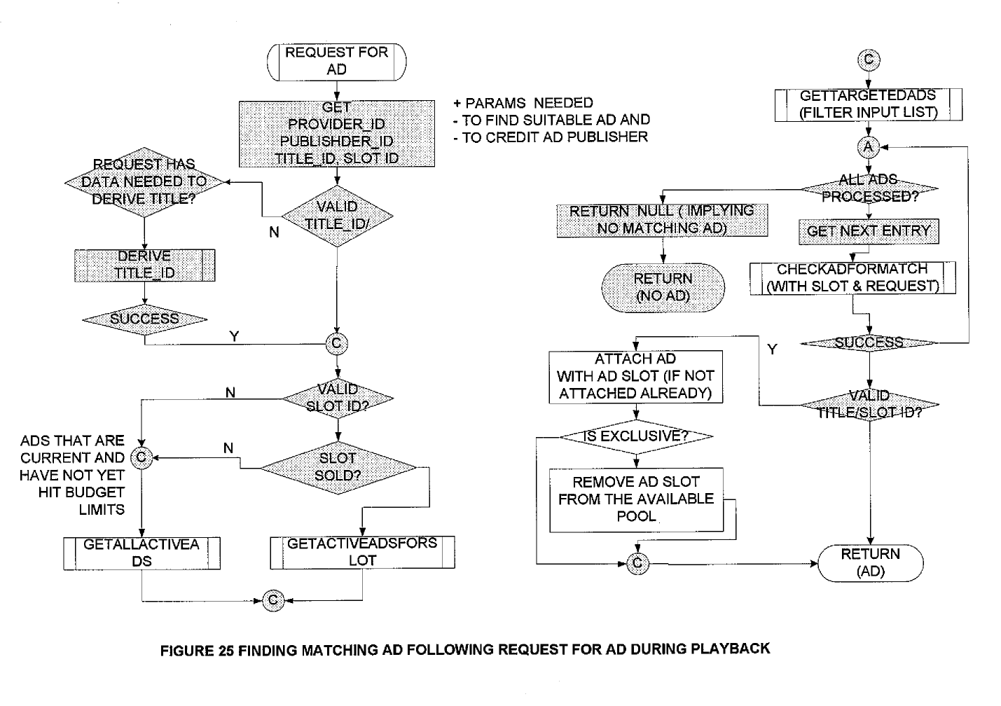

FIG. 25 illustrates an exemplary process flow involved in matching advertising with an advertising slot. This logic is used in finding advertising slot for an advertisement when the advertiser makes a request to find one or more advertising slots.

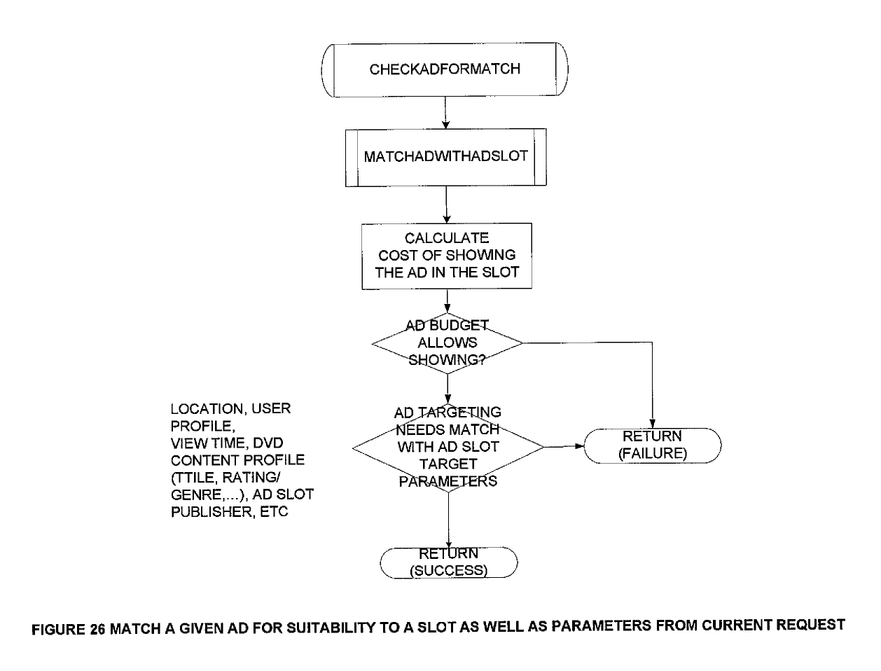

FIG. 26 illustrates an exemplary process flow involved in finding matching advertising following request from DVD player for an advertisement to be shown in an advertising slot.

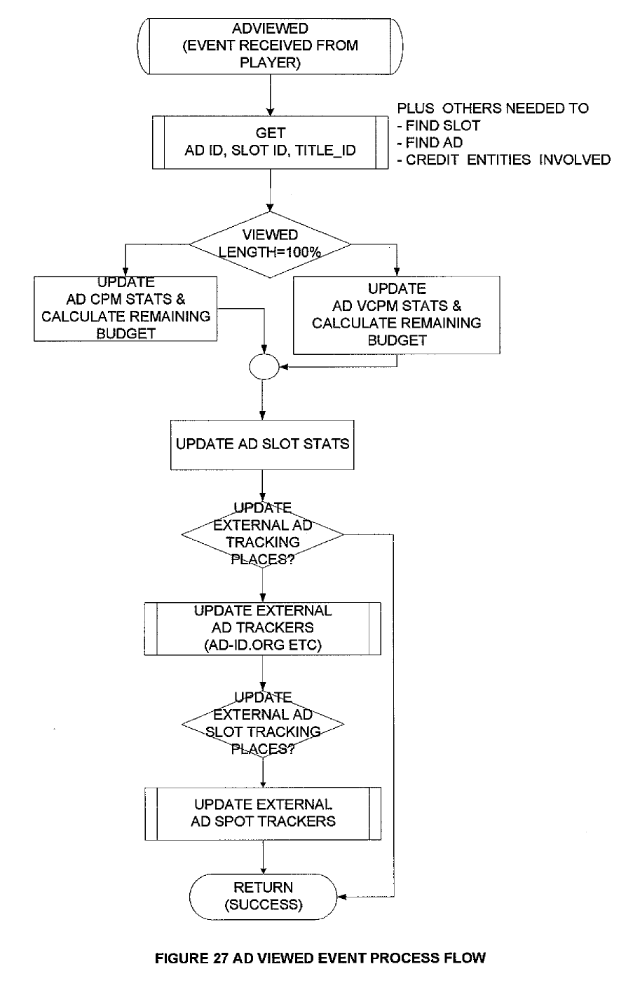

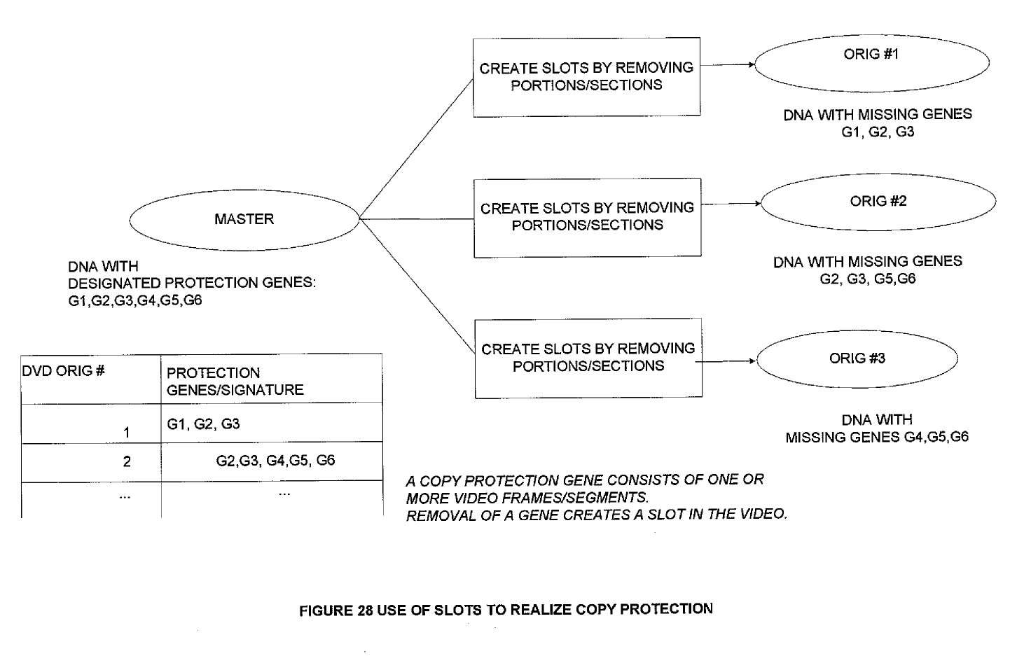

FIG. 27 illustrates an exemplary process flow involved in matching an advertisement with an advertising slot. This logic can be used in finding suitable advertisement/commercial for an advertising slot when player makes a request to get advertising. FIG. 28 illustrates an exemplary process flow involved in updating advertising statistics maintained at one or more tracking services associated with the advertisement.

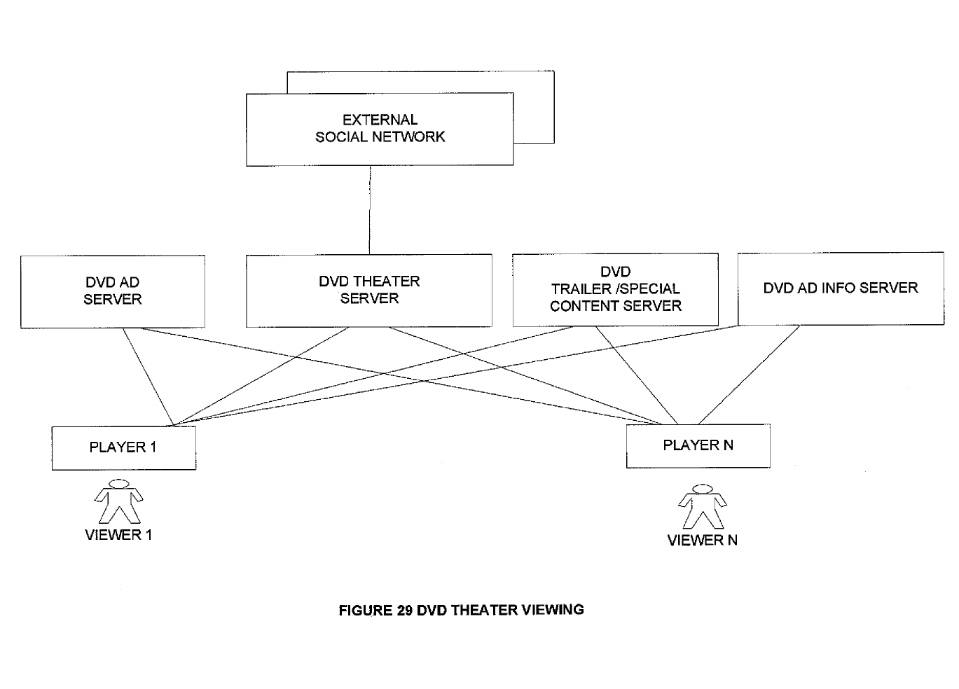

FIG. 29 illustrates exemplary process flow involved in DVD Trailer application and where the process executes in an application server functioning in the role of ‘DVD Trailer Server’ (block 88030 in FIG. 8, block 20030 in FIG. 20). It shows a process involved in handling request from viewer to send invite to a trailer, request to create a trailer, request to view a trailer.

To support trailer sharing, and in general sharing of auxiliary content shown in a slot, each slot can include information to help player display visual or audible hints to user to allow user to initiate sharing. DVD players that implement this disclosure may include software on the player and any remote control device they may provide with the player to provide for user to initiate sharing. For instance, a vendor may include a specific button on the player's control interface (via remote or otherwise) that may blink when shareable content is being shown on screen. When user presses that button it may result in screen that asks user to type in email id or mobile phone number or SIP (Session Initiation Protocol), IM or Skype™ address or social network specific contact information (e.g. joe@facebook.com, joe@myspace.com etc) of the user to whom share invite need to be sent. It may optionally ask a viewer to enter any message to be sent with the invite.

The input gathering interface may be provided by an application server (trailer server, ad server, etc) using HTML for instance, and where the player can launch a HTML browser when user activates share option and in whatever way player enables the user to activate the option. Alternatively, a player and application server may work together using a proprietary implementation, such as, where player shows screen to let user input information and provide the same to application server using proprietary and mutually agreed interface between them. Regardless of how input is gathered, a trailer application server (or in general application server associated with the auxiliary content shown) sends out a share invite to intended invitees. It is also possible, through mutual agreement between player and application server, for the player to send out invites directly if it implements a capability to do so.

FIG. 30 illustrates rendering options for use by interactive DVD applications enabled by this framework. It illustrates two possible options, among others possible based on these examples. One is a split-screen option that allows viewer to see and interact with the application (e.g., advertisements, theater, trailer and so on). The other, shown in FIG. 30 (b) is a dual screen option. Many video platforms (such as Blue-Ray players) offer multiple video and graphic planes and therefore 2 screen or multi-screen option should be relatively to realize. In the dual screen option, interactive content (comments, title/movie information, theater information, list of friends in theater or list of friends watching outside theater, advertisement, etc) can provide additional information in the second plane/screen using video, audio, graphics, and text. Auxiliary content output (with or without Interactivity) and interactive application output can be shown as HTML page that further contains video, graphics, audio, and text. The browser used to display HTML content can support tabbed frames (e.g. available in Mozilla® FireFox®) allowing realization of more than 2 screens in software regardless of platform support for more than 2 screens. These options available for applications to render their output are separate from rendering options for showing auxiliary content in slots as explained earlier in FIG. 3. In case auxiliary content shown in a slot enables interactivity then the portion of the screen that is allocated for the auxiliary content as per options shown in FIG. 3 can still use options shown in FIG. 30. For example, if an advertisement shown in a slot allows sharing of that advertisement then user interface of the slot needs to indicate to viewer using FIG. 30 (a) or FIG. 30 (b) that the particular advertisement (the auxiliary content) is shareable. This is similar to trailer sharing example for which server side process was illustrated in FIG. 29.

FIG. 31 shows an exemplary presentation organization/layout of DVD info to enable interactivity and to show archived interactive inputs (such as comments etc) along side DVD theater schedule.

Other embodiments of the disclosure will be apparent to those skilled in the art from consideration of the specification and practice of the disclosure disclosed herein. It is intended that the specification and examples be considered as exemplary only, with a true scope and spirit of the disclosure being indicated by the following claims.

What is claimed is:

1. A method for enabling advertising slots during playback of a digital video disc (DVD), the method comprising the steps of:
creating advertising slots on the DVD;
maintaining an inventory of the advertising slots;
storing of advertising content for each advertisement;
receiving a request for at least one advertisement to be played in the advertising slots;
retrieving content for the requested at least one advertisement; and
serving to the retrieved content based on the request.

2. The method of claim 1, wherein advertising slot information is embedded into the DVD to enable a player to play advertising slots at designated times and in accordance with a rendering preference of each slot.

3. The method of claim 1, wherein information of one or more advertising servers is embedded on the DVD to enable a player to fetch advertising slot information from one or more advertising servers

4. The method of claim 1, wherein information stored with each advertising slot contains a set of rendering rules for rendering the advertising slot

5. The method of claim 1, wherein information stored with each advertising slot contains a set of pricing rules.

6. The method of claim 1, wherein information stored with each advertising slot contains a list of allowed advertisers that can participate in an auction associated with the advertising slot.

7. The method of claim 1, wherein information stored with each advertising slot contains a list of advertisers that can not participate in an auction associated with the advertising slot.

8. The method of claim 1, wherein information is stored with each advertising slot to indicate timings that are to be treated as premium timings.

9. The method of claim 1, further comprising sending advertising slot information to a DVD player upon request.

10. The method of claim 1, wherein information of one or more advertising servers is embedded into the DVD to enable a player to fetch an address of one or more servers associated with the DVD.

11. The method of claim 1, wherein default advertisements are embedded on the DVD for use with one or more slots.

12. The method of claim 1, further comprising configuring preferences for the type of advertisements that can be shown in slots wherein the preferences are specified based on categories to optimize advertising revenue.

13. The method of claim 1, further comprising aggregating advertising slots for auction based on at least one rating of the DVD.

14. The method of claim 1, further comprising collecting feedback from a player to generate advertising metrics based on the length of the advertising watched.

15. The method of claim 1, further comprising notifying an advertiser providing the advertisement information about the advertisement when it is played at a DVD player.

16. The method of claim 1, wherein feedback from a player is used to calculate a charge for the advertisements.

17. The method of claim 1, further comprising paying an advertiser for advertisements shown in advertising slots based on CPM, CTC, or both.

18. The method of claim 1, wherein the advertisement comprise a prologue and epilogue that, if viewed, are used to consider the advertising as effectively viewed.

19. The method of claim 1, wherein an advertisement is considered viewed based on a threshold set by an advertiser.

20. The method of claim 1, wherein interactivity is supported with advertisements shown in one or more advertising slots is supported.

21. The method of claim 1, wherein the advertisement slots are configured based on guidelines from a content publisher.

22. A method of playing auxiliary content with playback of main content recorded on a digital medium, said method comprising:
identifying, during playback of the main content, at least one slot allocated for auxiliary content;
determining, from information in the at least one slot, a location of the auxiliary content;
retrieving the auxiliary content based on the information in the at least one slot; and
playing the retrieved auxiliary content during playback of the main content.

23. The method of claim 22, wherein one or more slots are set aside for serving enhanced or special content for DVD viewing including interactive content.

24. The method of claim 22, wherein viewers can share content shown in a slot so that the receiver of the share can view the content.

25. The method of claim 22, wherein content owner creates one or more slots meant to be trailers and which are allowed to be shared.

26. The method of claim 22, wherein content owner maintains popularity of each shareable content shown in slots by number of times it was shared, by number of times it was viewed, and by ratings received from viewers.

27. The method of claim 22, wherein viewers are allowed to comment or rate DVD at the end or during watching and where such comments/ratings are aggregated across other viewers and made available at online area meant for that DVD.

28. The method of claim 22, wherein a presentation code allows viewers to interact with each other while watching a DVD so that community features can be combined with DVD watching.

29. A method of maintaining an inventory of content to be served for advertisement slots configured on a digital video disk (DVD), said method comprising the steps of:
maintaining an inventory of advertising slots configured on a plurality of DVDs;
maintaining an inventory of content to be served in the advertising slots; and
serving content for an advertising slot based on a request received from a player.

30. The method of claim 29, wherein the inventory of advertising slots is organized based on DVD class, wherein a class is based on one of a CARA rating, a review rating, or genre.

31. The method of claim 29, wherein the inventory of advertising slots is organized into groups based on whether the slot is available.

32. The method of claim 29, wherein the inventory of advertising slots comprises information indicating at least one of a DVD Title, a disk ID, and a serial number.

33. The method of claim 29, further comprising calculating at least one of a title, disk ID, and serial number for a DVD.

34. The method of claim 29, further comprising providing at least some of the advertising slot information to a requesting player to enable the player to show advertisements.

35. The method of claim 29, further comprising maintaining view and click metrics of playback of the advertisement slots.

36. The method of claim 29, further comprising maintaining view and click metrics to determine a popularity of advertisements.

37. The method of claim 29, further comprising selecting content to be served to a player based on one of a profile of a viewer, profile of DVD content, time of viewing, and location of viewing.

38. The method of claim 29, further comprising serving content to the player based on a history of a viewer.

39. The method of claim 29, further comprising serving content based on product category.
